(19) United States
(12) Patent Application Publication
(10) Pub. No.: US 2009/0301601 A1
(43) Pub. Date: Dec. 10, 2009

(54) Apparatus and Method for Using Tetrazine-Based Energetic Material

(76) Inventors: Jon R. Enerson, Port Richey, FL (US); John H. Lucius, Safety Harbor, FL (US); David Battat, St. Peterburg, FL (US); Emile Battat, Allen, TX (US); Glenn Mackal, South Pasadena, FL (US)

Correspondence Address: Gray Robinson;ATTN: STEFAN V. STEIN/ IP DEPT., 201 N. Franklin Street, Suite 2200, Post Office Box 3324, TAMPA, FL, 33601-3324, US

(21) Appl. No.: 12/279,005

(22) PCT Filed: Feb. 13, 2007
(86) PCT No.: PCT/US07/03971

§ 371 Date: Jul. 22, 2009

Related U.S. Application Data
(60) Provisional application No. 60/773,382, filed on Feb. 13, 2006.
(60) Provisional application No. 60/855,987, filed on Nov. 1, 2006.
(60) Provisional application No. 60/859,058, filed on Nov. 15, 2006.

(51) Int. Cl. B65B 31/00; A62C 39/00; F02B 45/00; C06D 5/00; B60R 21/26

(52) U.S. Cl. 141/38; 169/12; 123/24 R; 102/530; 280/741

(57) ABSTRACT

The present invention comprises apparatus and methods employing a gas produced from a tetrazine-based energetic material such as that known as “BTATz” containing 3;6-BtS(1H-1,2,3,4-Tetrazol-5-ylamino)1-,2,4,5-tetrazine 3;6-BtS(1H-1,2,3,4-Tetrazol-5-ylamino)1-,2,4,5-tetrazine or salts thereof. The tetrazinebased energetic material is ignited through the use of a percussion cap, a piezoelectric crystal or a battery-supplied electric spark or by encapsulating it in a container that is then exposed to a burning flame. The gas produced upon ignition is employed a propellant such as to inflate life rafts, life vests, emergency evacuation slides, tires, air bags and other inflatable devices. The gas produced upon ignition is alternatively employed to power an engine and many other applications such as a fire suppressant.

### CROSS REFERENCE TO RELATED APPLICATIONS

This application claims the benefit of provisional patent applications: Inflator Employing A Propellant Produced From A Tetrazine-Based Energetic Material, Ser. No. 60/773,382 filed Feb. 13, 2006, Apparatus And Method For Employing Tetrazine-Based Energetic Material As A Propellant, Ser. No. 60/885,987 filed Nov. 11, 2006 and Apparatus And Method For Employing Tetrazine-Based Energetic Material To Produce A Fire Suppressant Gas, Ser. No. 60/859,058 filed Nov. 15, 2006, the disclosures of each of which are hereby incorporated by reference herein.

### BACKGROUND OF THE INVENTION

1. Field of the Invention

This invention relates to an apparatus and method for using tetrazine-based energetic materials. More particularly, this invention relates to an apparatus or method employing a gas produced from a tetrazine-based energetic material. This invention further relates to igniting the tetrazine-based energetic material. In some embodiments, the tetrazine-based energetic material is ignited through the use of a percussion cap, a piezoelectric crystal or a battery-supplied electric spark or by encapsulating it in a container that is then exposed to a burning flame. This invention further relates to using the gas produced upon ignition as a propellant such as to inflate life rafts, life vests, emergency evacuation slides, tires, air bags other inflatable devices. Still further, this invention relates to using the gas produced upon ignition in many other applications such as a fire suppressant or as an alternative vehicle fuel.

2. Description of the Related Art

Presently, tetrazine-based energetic materials are well-known, such as that known as “BTATz” containing 3;6-BIS(1H-1,2,3,4-Tetrazol-5-ylamino)-1,2,4,5-tetrazine or salts thereof, as disclosed in U.S. Pat. Nos. 6,458,227 and 6,657,059, the disclosures of each of which are hereby incorporated by reference herein. BTATz was developed by the Los Alamos Laboratory principally as an explosive for military applications. The gas produced by igniting BTATz has many beneficial properties that have been incorporated by the present invention in many commercial applications such using the gas as a propellant to inflate life rafts, life vests, emergency evacuation slides, tires, air bags and other inflatable devices or as an alternative vehicle fuel to power an engine and such as using the gas as a fire suppressant.

More specifically, by way of background in the inflation art, there exist many types of inflators designed to inflate inflatable articles such as personal floatation devices (life vests, rings and horseshoes), life rafts, buoys, emergency signaling equipment and emergency evacuation slides. Inflators typically comprise a body for receiving the neck of a gas cartridge of compressed gas such as carbon dioxide. A reciprocating piercing pin is disposed within the body of the inflator for piercing the frangible seal of the gas cartridge whereupon the compressed gas therein flows into an exhaust manifold of the inflator and then into the article to be inflated. Typically, a manually movable firing lever is operatively connected to the piercing pin such that the piercing pin pierces the frangible seal of the cartridge upon jerking of a ball lanyard. U.S. Pat. No. 3,809,288, the disclosure of which is hereby incorporated by reference herein, illustrates one particular embodiment of a manual inflator.

In the inflation art, the gas cartridge is usually sized to contain the volume of carbon dioxide necessary to inflate the article. Small inflatable articles such as life vests are inflated with a relatively small volume of carbon dioxide. Hence, smaller gas cartridges can easily be employed. Larger articles such as life rafts and emergency evacuation slides for aircraft, require significantly larger volumes of carbon dioxide. Hence, either larger gas cartridges, or a multiplicity of gas cartridges, or a combination of both, must be used in order to have a sufficient volume of carbon dioxide to fully inflate the article.

It is desirable in many applications in the inflation art to minimize the weight of the inflatable article. For example, in the aircraft industry, it is desirable to minimize the weight of every appliance in the aircraft including the gas cartridges used to inflate the life vests, life rafts and emergency escape slides. Likewise, in other applications it is often desired to minimize not only the weight but also the size of the gas cartridge employed in the inflatable equipment. Hence, there presently exists a need for lighter weight and smaller sources for inflation gas which produce the same or higher volume of a propellant than conventional carbon dioxide gas cartridges. In related inflation applications such as air bags and the like, there likewise exists a need for producing an environmentally safe gas to inflate the air bag. For example, with regard to air bags, it is noted that various prior art propellants have been used in automotive safety restraint air bags. Most of these prior art propellants are problematic due to excessive heat generated, high sensitivity to inadvertent ignition. Some may even be are toxic in their unburned or burned state. Current prior art air bag propellants often pose a risk to the environment and require special handling and disposal procedures. Additionally, many of the prior art pyrotechnic materials commonly used in automotive air bags pose a risk of being collected and reused as improvised explosive devices.

Related to minimizing harmful propellants used in air bags, in the fire suppressant art, there also presently exists a need for producing an fire-suppressing gas that is safe to humans. Likewise, there presently exists a need for an environment-friendly gas that can be employed as an alternative vehicle fuel to power an engine, thereby minimizing fossil fuel pollution and greenhouse gases.

Therefore, it is an object of this invention to provide an improvement which overcomes the aforementioned inadequacies of the prior art and provides an improvement which is a significant contribution to the advancement of using BTATz in a large variety of applications.

### SUMMARY OF THE INVENTION

For the purposes of summarizing the invention, the present invention comprises apparatuses and methods employing a gas produced from a tetrazine-based energetic material such as that known as “BTATz” containing 3;6-BIS(1H-1,2,3,4-Tetrazol-5-ylamino)-1,2,4,5-tetrazine or salts thereof, as disclosed in U.S. Pat. Nos. 6,458,227 and 6,657,059, the disclosures of each of which are hereby incorporated by reference herein. In some embodiments, the tetrazine-based energetic material is ignited according to the present invention through the use of a percussion cap, a piezoelectric crystal or a battery-supplied electric spark or by encapsulating it in a container that is then exposed to a burning flame. The gas produced upon ignition is employed a propellant such as to inflate life rafts, life vests, emergency evacuation slides, tires, air bags and other inflatable devices. The gas produced upon ignition is alternatively employed to power an engine. Alternatively, according to the present invention, the gas produced upon ignition is employed in many other applications such as a fire suppressant.

More specifically, BTATz is employed as a deflagrating gas generating propellant to provide principally nitrogen gas as the inflation gas medium. The BTATz material is chosen, in part, due to the non-toxic nature of the effluent gasses produced from the deflagration of the material and its non-explosive nature as an energetic material. The effluent gas temperatures of BTATz remain sufficiently low and have a very rapid cooling rate to allow use of the propellant in traditional life vest, life raft and other emergency inflatable device gas containment bladder devices without thermal damage to the device or contact or exposure harm to the user.

The charge or grain shape of the BTATz material as employed in various embodiments of inflator may be of a variety of forms or shapes as specifically required with regard to time pressure curves desired for the inflation event. The grain shape may be alternately formed as a loose powder, a pelletized shape, a monolithic single grain charge or any number of specific geomemes required to provide the desired deflagration rate and gas generation, as well as any number of desired packaging arrangements suited to various inflators for various purposes, including, but not limited to; life vests, life rafts, aircraft emergency escape slides. Additionally, a variety of other chemicals may be added to the BTATz material to alter the performance with regard to deflagration rate, gas effluent temperature or other properties as required for specific environments or applications for the inflator device. The BTATz material may employ a binder material in order to form specific grain shapes as previously mentioned. Binder materials may include PVA, (polyvinylalcohol), PEA, (polyethylacrylate), or other appropriate chemical materials to provide a binding property to the base material in order to maintain a specific structure or formation such as pellets, spherical balls or a monolithic grain shape. Addition of a binder material to the BTATz has demonstrated a notable reduction in the electrostatic discharge spark sensitivity of the material. In order to reliably initiate deflagration of BTATz with binder material, inclusion of “neat” material (without binder), may be utilized as a primary, spark sensitive, charge to facilitate ignition when employing an electrical spark as ignition means.

In the several embodiments of the invention, the inflator may be initiated by either manual or automatic means or by a combination of manual and automatic methods. Initiation or ignition of the BTATz charge in the inflator mechanism may be by means of, but not limited to, a pyrotechnic primary charge such as a commercial primary or percussion cap, electrical or mechanical pyrotechnic squib, electric match, spark generated by a stored electrical energy source such as a battery or generated by means of a Piezoelectric device. In an automatic initiation mode the inflator device may be triggered by either mechanical or electronic means. Mechanical initiation may comprise a pull type lanyard and lever arrangement that alternately either releases a mechanical hammer or firing pin to strike a primary percussion cap or activates a Piezoelectric generator to produce electric spark across a conductive gap to initiate the BTATz propellant.

Optional automatic initiation may be by means of a water immersion sensing electronic circuit that will trigger release of battery stored electric energy to produce a spark, activate a pyrotechnic squib, initiate an electric match, or trigger the release of a mechanical hammer or firing pin to impact a primary or percussion pyrotechnic cap. Alternately, automatic initiation may be by means of a water-soluble bobbin that upon dissolving, releases a hammer or firing pin arrangement to strike a percussion or primary cap.

One embodiment of the inflator device includes an actuating lever and cam arrangement that provides for multiple striking impacts of the hammer or firing pin mechanism against the primary or percussion cap upon a single pull of the lever. Another embodiment of the inflator mechanism includes a similar lever and cam arrangement that provides for multiple actuations of a piezoelectric spark generator. Both multiple actuation mechanisms serve to provide a safety factor to insure activation of the BTATz deflagration event.

Containment of the BTATz gas generating charge may be in a separate metal, thermoplastic, thermosetting plastic or elastomeric container that is readily attachable and detachable from the inflator mechanism body to facilitate ease of arming and rearming the device. One embodiment of the charge container employs both the gas generating BTATz material and a percussion or primary cap. Another embodiment of the charge container includes electrical contact points and an internal conductive spark gap arrangement. Charge containers may have hermetic sealing to preclude moisture entry into the chemical charge and ignition components.

Charge containers may be of varying sizes and geometric configurations to contain various quantities of BTATz material, various grain geometries or various specialized connections for different specific inflator devices.

Another embodiment of the inflator includes a means of indicating alternately a fired or unfired, (ready), state by displaying an appropriate color indicator or by means of a physical indicator.

The inflator may be fabricated from thermoplastic, thermosetting polymer, metal, elastomeric material or any combination thereof.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is an exploded view of a gas cartridge containing the BTATZ material fluidly connected to an inflatable article to inflate the article upon activation of the BTATZ material;

FIG. 2 is a cut-away view of a device using BTATz as a propellant for automotive safety restraint air bags;

FIG. 3 is a cut-away view of a device containing BTATz that may be thrown, propelled, dropped or otherwise introduced into a fire to suppress the same;

FIG. 4 is a cut-away view of a portable fire extinguisher containing BTATz;

FIG. 5 is a cut-away view of a solid-material fire extinguisher containing BTATz without other propellants;

FIG. 6 is a cross-sectional view of a BTATz inflator including an electronic, water sensing trigger that ignites the BTATz material upon being submerged in a body of water;

FIG. 7 illustrates a BTATz tire inflator including an adjustable pop-off valve that limits the amount of gas pressure during inflation of the tire;

FIG. 8 illustrates a BTATz inflator that may be heat-sealed to a life vest or other inflatable; and

FIG. 9 illustrates a BTATz alternative fuel engine in which quantities of BTATz material are sequentially ignited to produce supplies of nitrogen gas to drive the engine.

Similar reference numerals refer to similar parts throughout the several figures.

### DETAILED DESCRIPTION OF THE PREFERRED EMBODIMENTS

The present invention comprises an apparatus and method for employing a gas produced from a tetrazine-based energetic material such as that known as “BTATz” as a propellant in one or more of the devices disclosed in the patents and patent applications listed in Table I appended hereto, the disclosures of each of the patents and patent applications are hereby incorporated by reference herein. More particularly, the BTATz propellant may be employed in any device, system or application, such as those described in Table I, in which a source of harmless gas is needed to be generated from a supply of material.

Without limiting the scope of the preceding paragraph, referring to FIG. 1, one embodiment of the invention comprises a gas cartridge 1-10 having an outlet 1-12 for fluid connection to an inflatable article, shown generally as reference numeral 1-14. The gas cartridge 1-10 comprises a conical reaction chamber 1-16 that contains the BTATZ material 1-18. The conical reaction chamber 1-16 is desired to control the gas evolution rate as the BTATZ material 1-18 burns linearly (which is believed to be achievable through use of a binder). The conical chamber 1-16 is hermetically sealed and screen-off by a cover 1-20 to prevent moisture egress and hold the BTATZ material 1-18 in place in the chamber 1-16. The conical chamber 1-16 is mounted within a cylindrical housing 1-22 which provides mechanical stability and creates an air gap that affords a low thermal conductivity, and thus a high resistance to heat transfer. A hemispherical dome 1-24 is positioned over the cover 1-20 to provide a headspace volume for the nitrogen gas to pressurize to drive Joule-Thompson cooling through the outlet 1-12. Respective crimping flanges 1-26 allows the aforementioned parts to be crimped into a single unit that will withstand the pressure of the entire gas discharge from the deflagration of the BTATZ material 1-18.

Another embodiment of the invention comprises using BTATz as a propellant for automotive safety restraint air bags. BTATz is particularly suited to be employed as a propellant for air bags due to its high nitrogen gas output and low gas temperatures. Also, the BTATz material is nontoxic and environmentally safe and is non-detonable, rendering it unusable for nefarious purposes, such as improvised explosive devices. The high nitrogen gas output of BTATz allows less propellant to accomplish inflation of the air bag restraint than with current commonly used materials.

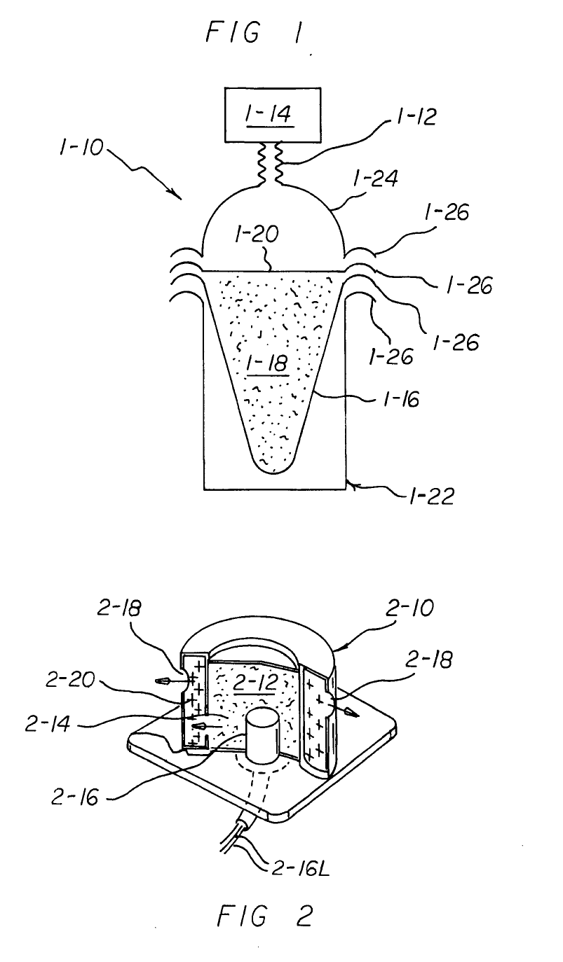

More particularly, referring to FIG. 2, the air bag inflation device of the invention comprises a vented housing 2-10 in which is positioned an internal cavity 2-12 filled with the BTATz propellant 2-14. A firing cap/squib/igniter 2-16 is positioned within the bottom of the cavity 2-12 with its firing leads 2-16L extending through the housing 2-10 for connection to a firing mechanism. A space may be provided between the vents 2-18 of the housing 2-10 and the internal cavity 2-12 to receive a filter 2-20 therein. The filter 2-20 functions to filter the gas produced by the propellant 2-14 upon firing.

Upon sensing an impact, the air bag firing mechanism is actuated to produce an electrical signal to fire the firing cap 2-16, whereupon the BTATz propellant 2-14 ignites to produce the nitrogen gas that is then filtered to exit the housing 2-10 and inflate the airbag.

Another embodiment of the invention comprise an apparatus and method for employing a gas produced from a tetrazine-based energetic material such as that known as “BTATz” as a fire suppressant in one or more of the devices disclosed in the patents and patent applications listed in Table II appended hereto, the disclosures of each of the patents and patent applications are hereby incorporated by reference herein. More particularly, the BTATz propellant may be employed in any device, system or application, such as those described in Table I, in which a source of harmless gas is needed to be generated from a supply of material. More particularly, the fire suppressant nitrogen gas produced upon ignition of the BTATz material may be employed in any device, system or application, such as those described above, in which a source of fire suppressant gas is needed to be generated from a supply of material.

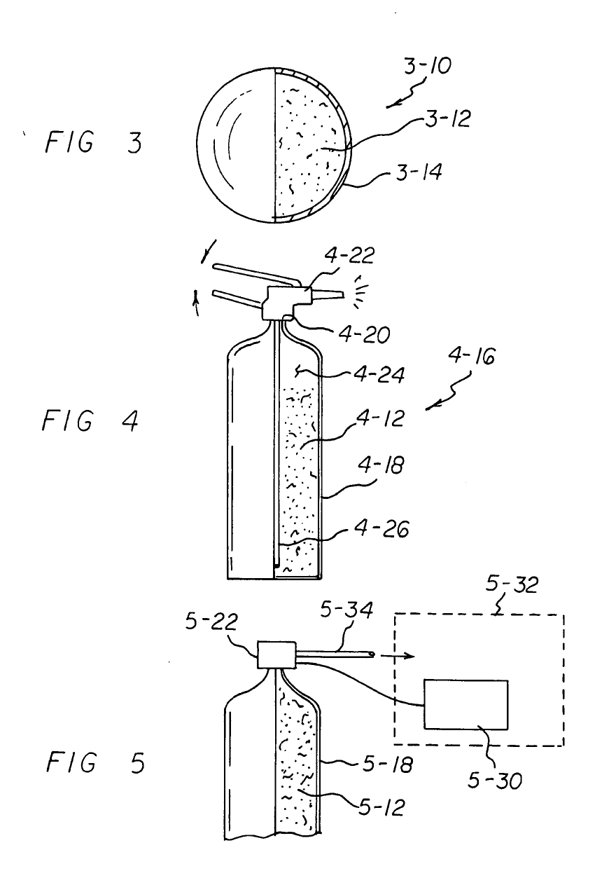

As shown in FIG. 3, in accordance with the spirit and scope of the invention and without limitation, one exemplary application includes filling a container 3-10 with the BTATz material 3-12 to be fully encapsulated therein. The container 3-10 is constructed of a material 3-14 such that when it is thrown, propelled, dropped or otherwise introduced into a fire, the material 3-14 constituting the container 3-10 is melted, burned, cracked-open or otherwise released to expose the BTATz material 3-12 to the fire, whereupon the BTATz material 3-12 is then ignited by the flames of the fire. Upon ignition of the BTATz material 3-12, a large volume of fire-suppressing nitrogen gas is produced to starve the fire of oxygen and thereby extinguish the fire. It is contemplated that the container 3-10 may comprise a variety of configurations and sizes for ease in being introduced into the fire.

More particularly, without limiting the spirit and scope of the invention, the container 3-10 may comprise a softball-sized flammable container 3-10 filled with the BTATz material 3-12 that is easily grasped by the human hand to be thrown into a burning fire. Once the soft-ball sized container 3-10 is in the fire, the flammable material 3-14 constituting the container 3-10 catches on fire whereupon the BTATz fire suppressant material 3-12 is ignited to produce a large volume of fire-suppressing nitrogen gas to extinguish the fire. Depending on whether the fire is burning in an enclosed space or is burning in the open, many of the soft-ball sized containers 3-10 may be thrown in as necessary to put out the fire. In the case of a forest fire, many, even thousands, of the soft-ball sized (or larger) containers 3-10 can be air-dropped into the fire.

As shown in FIG. 4, BTATz material 4-12 may be incorporated into portable fire extinguishers 4-16 with or without other propellants. For example, as shown in FIG. 4, similar to a conventional fire extinguisher 4-16 employing a propellant, a gas cylinder 4-18 may be partially filled via its opening 4-20 with the BTATz material 4-12. A conventional hand-operated dispensing valve/nozzle 4-22 is then installed in the opening and the cylinder 4-18 is pressurized with a gas 4-24. When needed to put out a fire, the nozzle 4-22 is pointed to the base of the fire and the valve 4-20 is actuated whereupon the pressurized gas 4-24 forces the BTATz material 4-12 from the bottom of the cylinder 4-18 up through a central tube 4-26 to then be propelled toward the base of the fire where it is ignited to produce a large volume of nitrogen gas that deprives the fire of oxygen thereby extinguishing the fire.

It is noted that the above-described “portable” extinguishers 4-16 may comprise a valve 4-22 that is actuated when a fire is sensed such that the extinguisher 4-16 may be mounted in a fixed location, such as in the bilge of a boat, to automatically release BTATz material 4-12 once a fire is detected.

The BTATz material may employed within a fire extinguisher 4-16 without a propellant. More particularly, a shown in FIG. 5, the valve 5-22 may include an igniter (e.g., squib, percussion cap or other electronic or mechanical spark-generator). With the cylinder 5-18 being filled with the BTATz material 5-12, it may be directly ignited by the igniter of the valve 5-22. Upon ignition within the cylinder 5-18, the expanding nitrogen gas produced from the burning BTATz material 5-12 pressurizes the cylinder 5-18. The pressurized cylinder 5-18 is thus “charged” and the nitrogen gas therein may then be immediately released (or released at will) to extinguish the fire (similar to gas fire suppression systems that store Halon, FM2000 or other fire-suppression gases). Indeed, igniter of the valve 5-22 may be remotely actuated via a sensor 5-30 in an area 5-32 to be protected (e.g., computer room). The container 5-12 may be fixedly mounted on one central location and its output 5-34 plumbed to the protected area 5-32 in which the sensor is located 5-30. In this manner, when a fire is detected in the protected area 5-32, the igniter of the valve 5-22 is actuated ignite the BTATz material 5-12 to produce a large volume of nitrogen gas which then flows through the piping 34 to be injected into the protected area 5-32 to extinguish the fire.

Thus, it should be appreciated that the BTATz fire suppressant material 5-12, coupled with an ignition system, may be used as a substitute for Halon or FM2000 in a large variety of fire suppression systems, such as those described in the above-listed patents and patent applications.

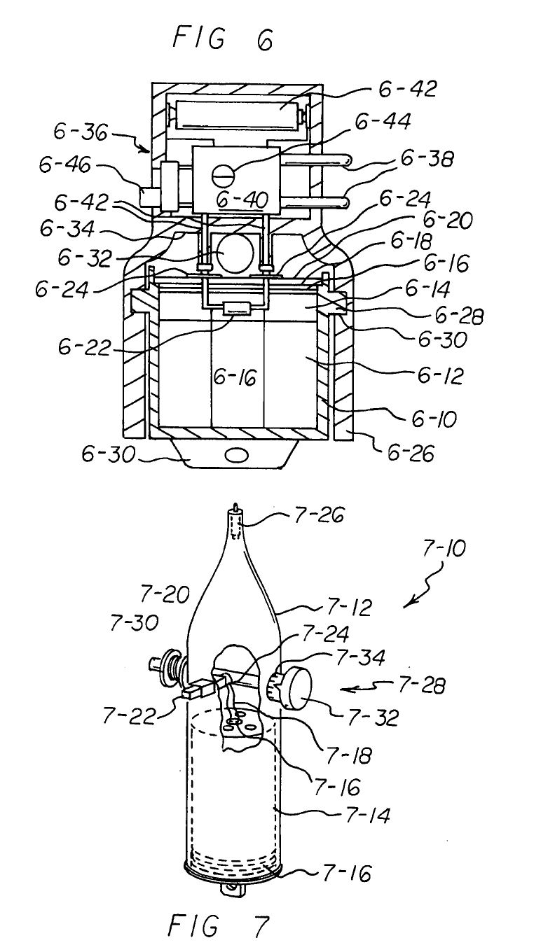

Referring to FIG. 6, in another embodiment of a BTATz inflator of the invention, a generally cylindrical BTATz charge container 6-10 is partially filled with an amount of BTATz material 6-12 and then the charge container 6-10 is filled with a primer charge 6-14. Preferably, a hollow central core 6-16 extends through the BTATz gas-generating charge 6-12 and the primer charge 6-14 of a specific grain shape that defines the burn rate of the BTATz material 6-12 once ignited by the primer charge 6-14. The charge container 6-10 is then sealed with a hermetic seal membrane 6-16 (e.g., a film). A particulate filter 6-18 is installed over the seal membrane 6-16 and then a vented cover 6-20 with a downward-extending igniter 6-22 is installed about the opened end of the charge container 6-10 with the igniter 6-22 extending into the hollow central core 6-16 of the primer charge 6-14. The exposed surface of the vented cover 6-20 includes swash-plate electrical contacts 6-24 electrically connected to the igniter 6-22 to fire the same upon application of an electrical voltage to the contacts 6-24. Upon firing of the igniter 6-22, the primer charge 6-14 is ignited which in turn ignites the main BTATz gas generating charge 6-12 to produce a supply of nitrogen gas at a rate determined by the grain shape employed. The nitrogen gas produced is vented from the charge container 6-10 via the vents in the cover 6-20.

The BTATz charge container 6-10 is dimensioned to be replaceably installed, preferably sealably, within a lower chamber of a generally cylindrical inflator housing 6-26 and held into position once installed by locking lugs 6-28 that lock into corresponding locking grooves 6-30 formed in the lumen of the inflator housing 6-26. The exposed end of the charge container 6-10 includes a finger tab 6-30 to facilitate installation of a fresh charge container 6-10 and then removal once the charge container 6-10 is spent (i.e., fired).

An exhaust port 6-32 is located in the lower chamber of the inflator housing 6-26 above the vents of the cover 6-20 of the charge container 6-10 such that upon ignition of the main BTATz gas generating charge 6-12 to produce the supply of nitrogen gas, the gas being vented therefrom is exhausted via the exhaust port 6-32 into the article to be inflated.

The inflator housing 6-26 further includes a separate upper chamber sealed from the lower chamber by an intermediate divider wall 6-34. The upper chamber contains an water-activated electronic assembly, generally indicated by numeral 6-36, that functions to supply a firing voltage to the electrical contacts 6-24 of the igniter 6-22 to fire the same when the inflator housing 6-26 is submerged in a body of water. More specifically, the electronic assembly 6-36 comprises a pair of water immersion contact sensors 6-38 extending through a wall of the upper chamber of the housing 6-26. The sensors 6-38 are electrically connected to a controller 6-40 contained within the upper chamber. The controller 640 optionally is composed of discrete electrical components, integrated circuits or a microcontroller powered by a battery source 642 also contained within the upper chamber. The controller 640 senses when the sensors 6-38 have been submerged in a body of water.

The controller 6-40 further comprises output contacts 642 that extend through the intermediate wall 6-34 to make electrical contact with the respective swash plate electrical contacts 6-24 of the igniter 6-22 when the charge container 6-10 is installed in the lower chamber of the housing 6-26. When the controller 6-40 senses that the sensors 6-38 have been submerged in a body of water, it produces an output voltage to its output contacts 6-42 to fire the igniter 6-22.

It is noted that optionally the controller 6-40 may further include a red/green status indicator LED 6-44 that extends through the wall of the upper chamber of the housing 6-26 to indicate the firing condition (i.e., green for ready and red indicating a spent charge container 6-10, low battery or other inoperative condition) of the inflator. Further optionally, the operation of the controller 640 may be controlled by an on/off mode switch 6-46 extending through the wall of the upper chamber housing 6-26. It is further noted that the sensors 6-38, the indicator LED 6-44 and the mode switch 6-46 are preferably sealed as they extend through the wall of the upper chamber to preclude any moisture from entering the upper chamber and otherwise damaging the operation of the controller 6-40. Finally, it is noted that the end of the upper chamber may be removable to allow replacement of the battery 642.

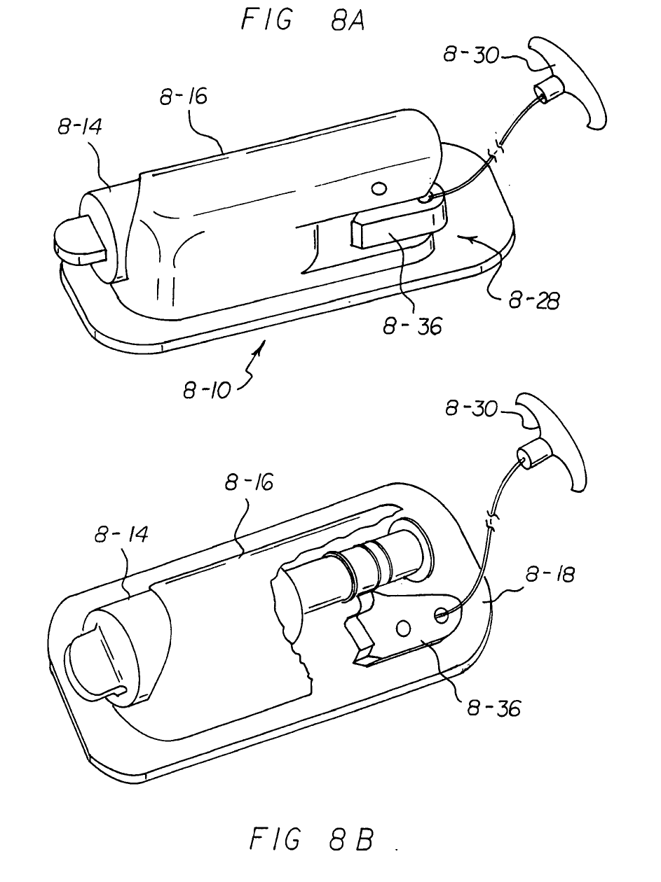

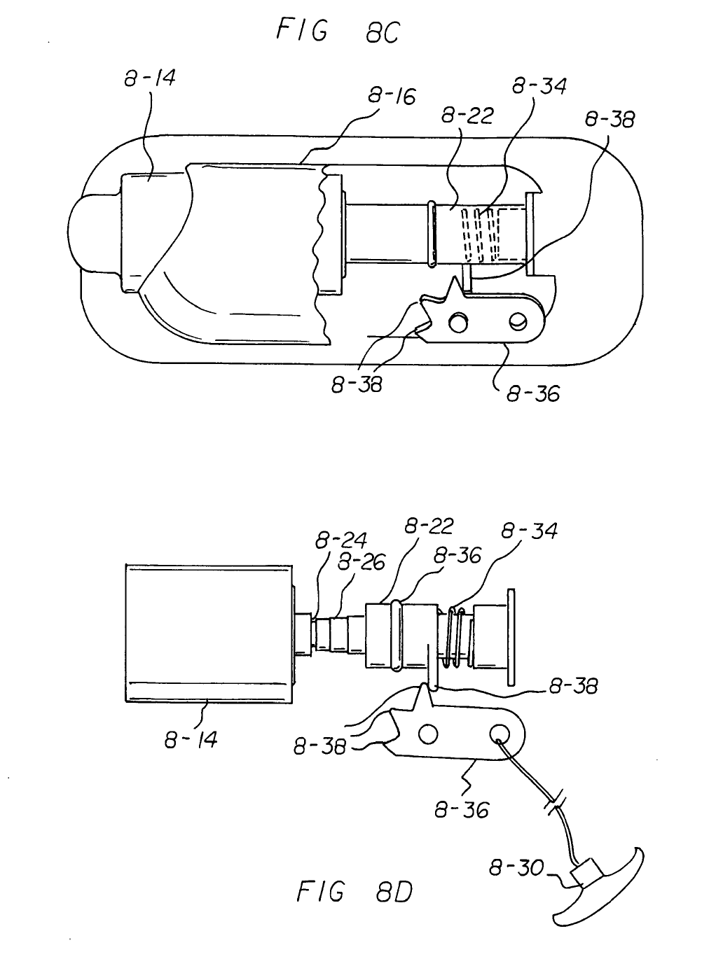

As shown in FIG. 7, still another embodiment of the BTATZ inflator of the invention, similar to that of FIG. 6, but configured to function as a tire inflator 7-10. More specifically, the tire inflator 7-10 of the invention comprises a generally cylindrical housing 7-12 that sealingly receives at is proximal end a replaceable BTATz charge container 7-14 by circumferential mating threads 7-16 on the outside of the charge container 7-14 and the lumen of the housing 7-12.

The charge container 7-14 includes a threaded vented cap 7-18 allowing filling. The charge container 7-14 is filled with a supply of BTATz material. A spark gap 7-16 is formed in the upper end of the charge container 7-14 for creating a spark when voltage is applied to its leads 7-18. The firing spark created is injected into the charge container 7-14 to ignite the BTATz material therein. As described above in relation to FIG. 6, the BTATz material may include a hollow core with a desired grain shape to control the degree of burning and hence the rate at which the nitrogen gas is produced. The nitrogen gas produced upon burning of the BTATz material is vented from charge container 7-14 into the distal end of the housing 7-12.

A piezoelectric mechanism 7-20 is mounted to the wall of the distal end of the housing 7-12. The piezoelectric mechanism 7-20 comprises a push-button 7-22 that when pressed, creates a spark of voltage by the piezoelectric that is supplied by internal electrical leads 7-24 to the leads 7-18 of the spark gap 7-16. Thus, it should be appreciated that upon depressing the push-button 7-22, the piezoelectric fires to create a spark of voltage that is supplied to the spark gap 7-16 to ignite the BTATz material in the charge container 7-14, whereupon the nitrogen gas produced therein is vented into the distal end of the housing 7-12.

The distal end of the housing is 7-12 is preferably tapered to receive a valve 7-26 that is designed to open a conventional inflation valve of a standard automotive tire, commonly referred to as a Schrader Valve. Consequently, during use to fill a tire, the valve 7-26 may be engaged into the tire's Schrader Valve and the push-button 7-22 depressed to fire the BTATz charge container 7-14, whereupon the nitrogen gas produced flows into the tire to inflate the same.

Preferably, in order to prevent over-inflation of the tire, a presettable pressure-limiting mechanism 7-28 is incorporated into the housing 7-12 to automatically exhaust gas pressure to the atmosphere whenever the pressure of the gas exceeds the presettable pressure. IN one embodiment, the presettable pressure-limiting mechanism comprises an adjustable pop-off relief valve 7-30 whose pop-off pressure is presettable by a dial 7-32 with a pressure indicator lines 7-34 formed thereon. The indicator lines 7-34 allows informed dialing of the desired presettable pressure (e.g., 30 psi) whereupon any excess gas pressure is automatically vented from the housing 7-12, thereby assuring that the tire is inflated only to such desired pressure (e.g., 30 psi).

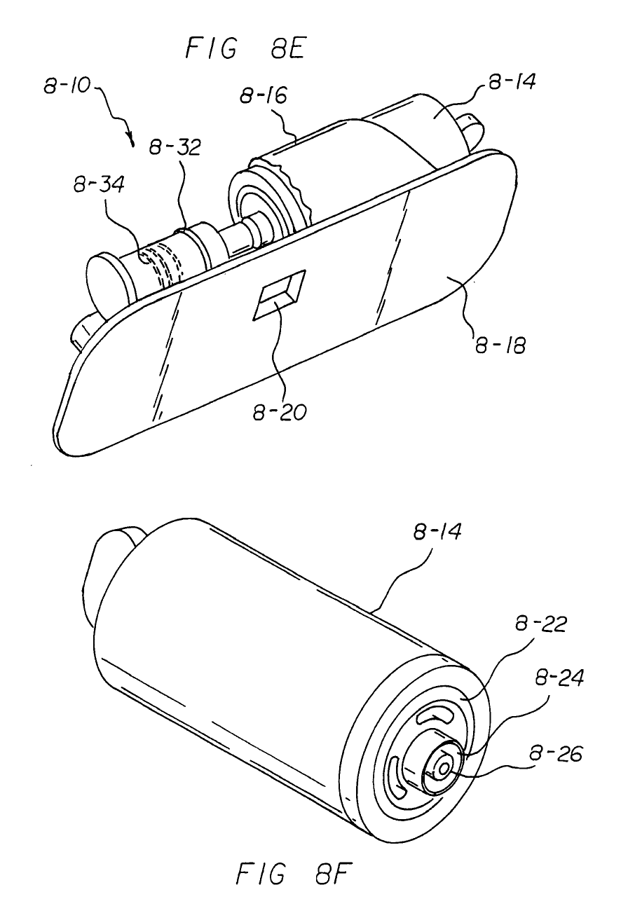

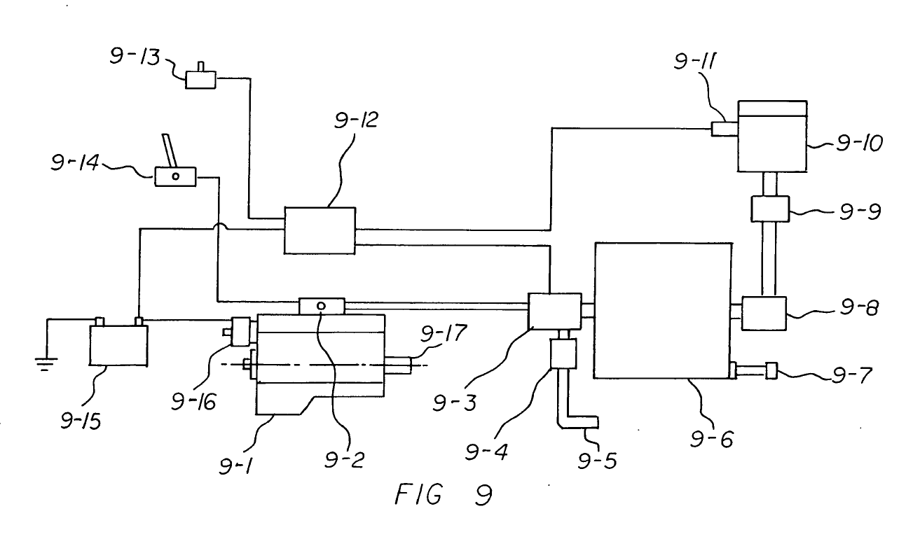

As shown in FIG. 8, a further embodiment of the BTATz inflator of the invention comprises an inflator 8-10 that employs a percussion cap 8-12 to ignite a charge container 8-14 filled with BTATz material 8-14. In the specific embodiment illustrated, an inflator housing 8-16 comprises a generally rectangular configuration having a peripheral flange 8-18 that is intended to be heat-sealed to an inflatable article such as a life vest, life raft, evacuation chute or the like. The underside of the inflator housing 8-16 includes an exhaust port 8-20 fluidly connected to interior of the inflatable article to inflate the same upon firing of the charge container 8-14.

Similar to the previous embodiments disclosed above, the charge container 8-14 comprises a generally cylindrical design that is removably installed into the inflator housing 8-16, preferably sealingly by means of an O-ring 8-22. The vented end cover of the charge container 8-14 allows filing with a desired quantity of BTATz material which, upon ignition, produces a desired volume of nitrogen gas to inflate the inflatable article.

The vented end cover of the charge container 8-14 comprises a percussion cap seat 8-24 configured to receive a percussion cap 8-26. The percussion cap 8-26 functions upon striking to inject a spark into the charge container 8-14 to ignite the BTATz material contained therein.

A firing mechanism, generally indicated by numeral 8-28, is provided to strike the percussion cap 8-26 one or more times upon the jerking of a lanyarded pull handle 8-30. More specifically, the firing mechanism 8-28 comprises a generally cylindrical firing hammer 8-32 reciprocatingly positioned within an elongated bore 8-34 that is forcibly urged toward the percussion cap 8-26 by a firing spring 8-34. An O-ring 8-36 is fitted about the firing hammer 8-22 to seal with the bore 8-34, thereby precluding any blow-by of the nitrogen gas upon firing.

The lanyarded pull handle 8-30 is coupled to a pivotal trigger lever 8-36. The trigger lever 8-36 includes at least one lobe 8-38 in alignment with an integral tang 8-38 extending transversely from the firing hammer 8-32. As the pull-handle 8-30 is jerked, the lobe 8-38 pulls back the firing hammer 8-32 against the force of the firing spring 8-34 as the trigger lever 8-36 is pivoted until the lobe 8-38 slips off of the tang 8-38 to release the spring-loaded firing hammer 8-22. Upon releasing of the spring-loaded firing hammer 8-22, the hammer 8-22 is forcibly urged by the spring 8-34 toward the percussion cap 8-26 to strike the same and cause it to fire, thereby producing the nitrogen gas that is then vented from the charge container 8-14 from the housing 8-16 via exhaust port 8-20 to inflate the inflatable article.

As illustrated, preferably the trigger lever 8-36 includes plural lobes 8-34 (e.g., three) such that upon a single jerking of the pull handle 8-30, each of the lobes 8-34 sequentially pulls back the firing hammer 8-32 and then slips off the tang 8-38, thereby firing the hammer 8-

[symbol]

A control unit 9-12 receives a signal from a pressure transducer 9-18 when the gas pressure in the storage tank drops below a predetermined level, at which point the control unit 9-12 provides an electric current to the igniter 9-11 to fire a BTATz charge in the combustion chamber 9-10. The combustion chamber may contain several BTATz charges, which can be independently fired as needed to maintain the predetermined pressure level in the storage tank 9-6.

In the event of an over-pressure condition in the storage tank, an emergency pressure relief valve 9-4 opens and exhausts gas to the atmosphere through an exhaust tube 9-5. Once the gas pressure drops to the determined safe level, the relief valve 9-4 closes.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

TABLE I
PROPELLANT APPARATUSES AND METHODS

| Publication | |
|---|---|
| Number | Title |
| RE36,296 | Propellant composition for automotive safety applications |
| RE30,327 | Inflator seal |
| RE36,587 | Inflatable seat belt having bag filter |
| RE36,661 | Inflatable seat belt with leak detection device |
| RE33,938 | Aspirating/venting air bag module assembly |
| 3,934,984 | Gas generator |
| 3,938,826 | Aspirated vehicle occupant restraint system |
| 3,942,051 | Shock actuated electrical pulse generator |
| 3,942,819 | Safety belt tensioning device |
| 3,966,226 | Fluid supply for occupant restraint system |
| 3,971,322 | Pressure actuated tube primer |
| 4,008,830 | Liquid dispenser using a non vented pump and a collapsible plastic bag |
| 4,023,643 | Deceleration-responsive passenger-restraining device for motor vehicles |
| 4,050,483 | Inflation surge delay |
| 4,061,088 | Electric detonating fuse assembly |
| 4,179,327 | Process for coating pyrotechnic materials |
| 4,198,075 | Safety installation in motor vehicles with a knee impact element |
| 4,200,615 | All-pyrotechnic inflator |
| 4,203,786 | Polyethylene binder for pyrotechnic composition |
| 4,203,787 | Pelletizable, rapid and cool burning solid nitrogen gas generant |
| 4,238,253 | Starch as fuel in gas generating compositions |
| 4,243,248 | Air bag system for the protection of the passengers of motor vehicles in case of |
| | accidents |
| 4,244,758 | Ignition enhancer coating compositions for azide propellant |
| 4,246,051 | Pyrotechnic coating composition |
| 4,249,632 | Safety device for the protection of pedestrians |
| 4,369,079 | Solid non-azide nitrogen gas generant compositions |
| 4,369,707 | Short circuit fuse for electrical igniters |
| 4,370,181 | Pyrotechnic non-azide gas generants based on a non-hydrogen containing tetrazole |
| | compound |
| 4,370,930 | End cap for a propellant container |
| 4,397,596 | Method of making container for gas generating propellant |
| 4,414,902 | Container for gas generating propellant |
| 4,424,914 | Air bag explosive device |
| 4,437,681 | Inflator for a protective inflatable cushion system |
| 4,441,632 | Soft shell aerosol dispenser unit |
| 4,462,244 | Apparatus for field testing a smoke detector |
| 4,484,577 | Drug delivery method and inhalation device therefor |
| 4,533,416 | Pelletizable propellant |
| 4,580,810 | Air bag system |
| 4,600,123 | Propellant augmented pressurized gas dispensing device |
| 4,604,151 | Method and compositions for generating nitrogen gas |
| 4,664,234 | Self pressurized damper |
| 4,706,990 | Mechanical impact sensor for automotive crash bag systems |
| 4,758,287 | Porous propellant grain and method of making same |
| 4,761,254 | Method of and apparatus for fabricating a tool to form an asymmetrical constant |
| | cross section bore in the propellant in a solid rocket motor |
| 4,766,799 | Method of and apparatus for fabricating a tool to form an asymmetrical constant |
| | cross section bore in the propellant in a solid rocket motor |
| 4,798,142 | Rapid buring propellant charge for automobile air bag inflators, rocket motors, and |
| | igniters therefor |
| 4,806,180 | Gas generating material |
| 4,834,817 | Gas-generating composition |
| 4,845,377 | Circuit arrangement for the actuation of a safety system |
| 4,864,086 | Vehicle deceleration sensor |
| 4,865,635 | Filter assembly for non-welded inflator device |
| 4,865,667 | Gas-generating composition |
| 4,877,264 | Aspirating/venting air bag module assembly |
| 4,881,754 | Safety device for the occupant of the central rear seat position in a motor vehicle |
| 4,890,860 | Wafer grain gas generator |
| 4,902,036 | Deflector ring for use with inflators with passive restraint devices |
| 4,907,819 | Lightweight non-welded gas generator with rolled spun lip |
| 4,913,461 | Airbag module and method of making same |
| 4,915,410 | Vehicle air bag module and method of assembly |
| 4,915,411 | Crash sensor with improved activation for stabbing primer |
| 4,919,897 | Gas generator for air bag |
| 4,923,212 | Lightweight non-welded inflator unit for automobile airbags |
| 4,927,172 | Mechanical acceleration sensor |
| 4,928,991 | Aspirating inflator assembly |
| 4,938,140 | Deceleration sensor |
| 4,938,501 | Inflator housing structure |
| 4,944,527 | Integral retainer, heat shield and assembly |
| 4,955,638 | Deceleration sensor having safety catch means |
| 4,981,534 | Occupant restraint system and composition useful therein |
| 4,982,664 | Crash sensor with snap disk release mechanism for stabbing primer |
| 4,998,751 | Two-stage automotive gas bag inflator using igniter material to delay second stage |
| | ignition |
| 5,002,309 | Automatic mobile |
| 5,005,486 | Igniter for airbag propellant grains |
| 5,015,311 | Primary/detonator compositions suitable for use in copper cups |
| 5,019,192 | Primary/detonator compositions suitable for use in aluminum cups |
| 5,019,220 | Process for making an enhanced thermal and ignition stability azide gas generant |
| 5,022,674 | Dual pyrotechnic hybrid inflator |
| 5,024,160 | Rapid burning propellant charge for automobile air bag inflators, rocket motors, and |
| | igniters therefor |
| 5,031,932 | Single pyrotechnic hybrid inflator |
| 5,033,772 | Hybrid inflator |
| 5,035,757 | Azide-free gas generant composition with easily filterable combustion products |
| 5,043,030 | Stab initiator |
| 5,046,429 | Ignition material packet assembly |
| 5,058,921 | Linear bilateral inflator module |
| 5,060,974 | Gas inflator apparatus |
| 5,062,365 | Rapid burning propellent charge for automobile air bag inflators, rocket motors, and |
| | igniters therefor |
| 5,066,038 | Driver side hybrid inflator and air bag module |
| 5,071,161 | Air bag restraint system with venting means |
| 5,076,607 | Hybrid inflator |
| 5,078,422 | Gas inflator apparatus |
| 5,089,069 | Gas generating composition for air bags |
| 5,091,992 | Motorcyclist's air strips |
| 5,092,750 | Device for the compression and storage of air |
| 5,098,123 | Electrothermal inflatable restraint system |
| 5,100,172 | Inflator module |
| 5,104,727 | Air bag laminates |
| 5,128,177 | Method and apparatus of coating a vehicle frame |
| 5,140,906 | Airbag igniter having double glass seal |
| 5,143,567 | Additive approach to ballistic and slag melting point control of azide-based gas |
| | generant compositions |
| 5,149,129 | Gas generator |
| 5,160,386 | Gas generant formulations containing poly(nitrito) metal complexes as oxidants and |
| | method |
| 5,161,820 | Inflatable air bag safety device for motor vehicles |
| 5,165,830 | Mass transit vehicle |
| 5,179,982 | Apparatus for discharging a fluid and, more particularly, for spraying a liquid |
| 5,184,846 | Inflator assembly |
| 5,197,758 | Non-azide gas generant formulation, method, and apparatus |
| 5,197,759 | Air bag collision safety device |
| 5,199,740 | Hybrid inflator for air bag |
| 5,203,427 | Fire escape ladder with integral air cushion |
| 5,207,450 | Aspirated air cushion restraint system |
| 5,221,107 | Prefilter assembly |
| 5,223,184 | Enhanced thermal and ignition stability azide gas generant |
| 5,224,734 | Gas generator for air bags having vertical stack arrangement |
| 5,230,287 | Low cost hermetically sealed squib |
| 5,233,141 | Spring mass passenger compartment crash sensors |
| 5,236,675 | Gas generator with circumferential joints |
| 5,243,492 | Process for fabricating a hermetic coaxial feedthrough |
| 5,246,083 | Inflatable air bag for motor vehicles |
| 5,249,826 | Inertial mass safety system activation for personal vehicles |
| 5,255,938 | Tubular gas generator for an inflatable impact cushion |
| 5,256,904 | Collision determining circuit having a starting signal generating circuit |
| 5,257,818 | Apparatus for rapidly changing the temperature of a device in an inflatable restraint |
| | system |
| 5,257,819 | Hybrid inflator |
| 5,259,644 | Ignition unit, in particular for an air bag gas generator |
| 5,260,038 | Gas generator for air bags with circumferentially disposed blades |
| 5,263,740 | Hybrid air bag inflator |
| 5,273,311 | Gas generator |
| 5,273,722 | Gas generator |
| 5,277,440 | Air bag retention device |
| 5,286,054 | Aspirating/venting motor vehicle passenger airbag module |
| 5,294,414 | Gas generator, in particular, a tubular gas generator for an air bag |
| 5,295,709 | Inertial mass safety system activation of an air bag in personal vehicles |
| 5,305,914 | Pressurized gas bottle discharge device |
| 5,308,108 | Manifold or retainer for a gas generator |
| 5,309,138 | Vehicle collision detecting method employing an acceleration sensor |
| 5,314,203 | Driver-side module attach bracket |
| 5,320,382 | Pulsed pressure source particularly adapted for vehicle occupant air bag restraint |
| | systems |
| 5,322,018 | Surface-initiating deflagrating material |
| 5,322,322 | Side impact head strike protection system |
| 5,324,075 | Gas generator for vehicle occupant restraint |
| 5,331,126 | Pressure switch apparatus for monitoring pressure level in an enclosed chamber and |
| | methods of calibrating same and for making a movable contact arm for use therewith |
| 5,338,061 | Air bag having double-wall construction |
| 5,340,147 | Air bag inflator assembly |
| 5,342,081 | Air bag module with top mounted bag |
| 5,345,873 | Gas bag inflator containing inhibited generant |
| 5,345,875 | Gas generator |
| 5,345,876 | Hybrid inflator |
| 5,351,619 | Gas generator ignited by lamina or film |
| 5,351,988 | Hybrid inflator with staged inflation capability |
| 5,354,094 | Air-bag arrangement |
| 5,360,956 | Acceleration sensor for vehicle |
| 5,362,100 | Control circuit for a compressed gas inflator device |
| 5,364,127 | Inflator assembly |
| 5,372,380 | Filter and method of forming |
| 5,372,381 | Air bag with inflatabe ribs |
| 5,374,407 | Gas generator with porous outer wall |
| 5,378,011 | Air bag assembly |
| 5,378,012 | Lid structure of air bag system |
| 5,378,018 | Process for inflating a gas cushion and safety system of the air bag type |
| 5,383,388 | Starting device |
| 5,387,296 | Additive approach to ballistic and slag melting point control of azide-based gas |
| | generant compositions |
| 5,388,322 | Method of making a shatterproof air bag inflator pressure vessel |
| 5,397,543 | Gas generator |
| 5,398,967 | Air bag inflator |
| 5,401,340 | Borohydride fuels in gas generant compositions |
| 5,403,035 | Preparing air bag vehicle restraint device having cellulose containing sheet |
| | propellant |
| 5,403,036 | Igniter for an air bag inflator |
| 5,404,263 | All-glass header assembly used in an inflator system |
| 5,406,889 | Direct laser ignition of ignition products |
| 5,407,728 | Fabric containing graft polymer thereon |
| 5,419,875 | Gas generator with novel nozzle structure |
| 5,419,975 | Inorganic ceramic paper, its method of manufacture and articles produced therefrom |
| 5,429,691 | Thermite compositions for use as gas generants comprising basic metal carbonates |
| | and/or basic metal nitrates |
| 5,431,101 | Low cost hermetically sealed squib |
| 5,431,102 | Mechanical acceleration sensor |
| 5,431,448 | Three-point safety belt system for motor vehicles |
| 5,437,188 | Tell tale device for a pressure vessel |
| 5,437,229 | Enhanced thermal and ignition stability azide gas generant intermediates |
| 5,439,250 | Inflator for air bag device |
| 5,439,537 | Thermite compositions for use as gas generants |
| 5,454,586 | Driver side air bag module with extruded housing |
| 5,457,991 | Mechanical acceleration sensor |
| 5,458,706 | Solid pyrotechnic compositions with a thermoplastic binder and a polybutadiene |
| | silylferrocene plasticizer |
| 5,460,407 | Restraint system for vehicle occupants having laser ignition for an air bag gas |
| | generator |
| 5,462,306 | Gas generator for vehicle occupant restraint |
| 5,462,308 | Occupant protecting system for vehicle |
| 5,464,246 | Inflatable tubular cushions for crash protection of seated automobile occupants |
| 5,466,002 | Inflatable seat belt with leak detection device |
| 5,466,003 | Inflatable seat belt having bag filter |
| 5,468,013 | Dual air bag system for occupant restraint |
| 5,470,104 | Fluid fueled air bag inflator |
| 5,472,534 | Gas generant composition containing non-metallic salts of 5-nitrobarbituric acid |
| 5,474,328 | Stored gas hybrid driver inflator |
| 5,480,181 | Side impact head strike protection system |
| 5,486,210 | Air bag fabric containing graft polymer thereon |
| 5,486,248 | Extrudable gas generant for hybrid air bag inflation system |
| 5,487,561 | Safety bag inflation apparatus using a liquid propellant gas generator |
| 5,489,118 | Air bag inflator |
| 5,492,364 | Rupturable plastic housing for an air bag inflator |
| 5,494,312 | Autoignition of a fluid fueled inflator |
| 5,501,152 | Air bag gas generator with spontaneous ignition agent |
| 5,503,079 | Linear gas generant and filter structure for gas generator |
| 5,504,288 | Sensor for use with air bag inflator and method for making |
| 5,507,890 | Multiple layered gas generating disk for use in gas generators |
| 5,507,891 | Propellant composition for automotive safety applications |
| 5,513,572 | Hybrid inflator |
| 5,516,146 | Fastenerless airbag mounting |
| 5,516,377 | Gas generating compositions based on salts of 5-nitraminotetrazole |
| 5,518,271 | Inertial mass safety system activation of a seat belt restraint system in personal |
| | vehicles |
| 5,525,306 | Gas generator system |
| 5,527,062 | Air bag apparatus for impact protection |
| 5,527,067 | Gas generator formed with electron beam welding |
| 5,529,337 | Air bag device |
| 5,531,473 | Fluid fuel-containing initiator device for an air bag inflator |
| 5,531,941 | Process for preparing azide-free gas generant composition |
| 5,536,040 | Inflator for side impact air bag |
| 5,538,567 | Gas generating propellant |
| 5,538,568 | Extrudable gas generant for hybrid air bag inflation system |
| 5,542,688 | Two-part igniter for gas generating compositions |
| 5,542,695 | Air bag deployment system |
| 5,542,701 | Wire track with integral sealing mechanism and inflator |
| 5,542,997 | Gas-generating mixture |
| 5,544,687 | Gas generant compositions using dicyanamide salts as fuel |
| 5,544,913 | Protective device for protecting vehicle occupant |
| 5,544,916 | Two piece inflator housing |
| 5,547,214 | Side impact soft pack air bag module |
| 5,547,217 | Air bag inflator and method of manufacture thereof |
| 5,549,769 | High temperature stable, low input energy primer/detonator |
| 5,551,343 | Special geometry generant bodies for automotive gas bag inflator |
| 5,551,725 | Vehicle airbag inflator and related method |
| 5,552,472 | Fabric containing graft polymer thereon |
| 5,553,888 | Snap-on, removable steering wheel with integral airbag housing |
| 5,556,127 | Seat mounted side impact module |
| 5,556,132 | Vehicle occupant restraint with auto ignition material |
| 5,557,061 | High temperature stable, low input energy primer/detonator |
| 5,560,642 | Driver air bag module assembly |
| 5,562,303 | Pyrotechnic mixture and gas generator for an airbag |
| 5,564,734 | Door mounted air bag assembly |
| 5,566,543 | PVC-based gas generant for hybrid gas generators |
| 5,566,972 | Air bag device |
| 5,567,536 | Inorganic ceramic paper, its method of manufacturing and articles produced |
| | therefrom |
| 5,570,904 | Air bag inflator with movable container |
| 5,571,988 | Gas-producing material |
| 5,575,497 | Method for developing air bag for vehicle |
| 5,575,499 | Inflator for air bag device |
| 5,577,769 | Hybrid inflator for inflating air bags |
| 5,580,086 | Crash protection method and apparatus |
| 5,582,422 | Inflator mounting structure |
| 5,582,426 | Vented ignition cup in stored fluid inflator |
| 5,584,505 | Inflator assembly |
| 5,585,597 | Air bag inflator |
| 5,586,386 | Sensor for use with air bag inflator and method for making |
| 5,586,782 | Dual pressure side impact air bag |
| 5,589,141 | Use of mixed gases in hybrid air bag inflators |
| 5,592,812 | Metal complexes for use as gas generants |
| 5,593,180 | Dual chamber inflator for side impact air bag |
| 5,597,179 | Airbag inflation devices and methods |
| 5,601,308 | Inflator, inflation fluid heater and assembly methods |
| 5,607,180 | Airbag inflation devices and methods |
| 5,607,181 | Liquid-fueled inflator with a porous containment device |
| 5,615,914 | Inflatable metal bladders for automobile passenger protection |
| 5,622,380 | Variable nonazide gas generator having multiple propellant chambers |
| 5,624,134 | Gas generator formed with electron beam welding |
| 5,628,528 | Dual chamber nonazide gas generator |
| 5,630,616 | Seat frame integrated air bag inflator |
| 5,630,618 | Hybrid inflator with a valve |
| 5,635,665 | Linear gas generant and filter structure for gas generator |
| 5,639,116 | Instrument panel structure in vehicle |
| 5,642,904 | Two piece inflator housing |
| 5,648,634 | Electrical initiator |
| 5,649,466 | Method of rapidly deploying volume-displacement devices for restraining movement |
| | of objects |
| 5,652,389 | Non-contact method and apparatus for inspection of inertia welds |
| 5,653,464 | Airbag system with self shaping airbag |
| 5,658,011 | Air bag apparatus of a tire's air pressure sensing system for a vehicle |
| 5,659,150 | Gas generating composition with cyanamide and transition metal nitrate |
| 5,659,295 | Sliding piston pressure sensing device |
| 5,660,412 | Hybrid inflator |
| 5,660,606 | Inflator filter for producing helical gas flow |
| 5,672,843 | Single charge pyrotechnic |
| 5,673,935 | Metal complexes for use as gas generants |
| 5,681,904 | Azido polymers having improved burn rate |
| 5,682,013 | Gas generant body having pressed-on burn inhibitor layer |
| 5,683,104 | Combustion moderation in an airbag inflator |
| 5,690,356 | Integrated switch for air bag deactivation |
| 5,692,773 | Air bag module with bendable base for mounting cover |
| 5,697,638 | Vehicle steering wheel arrangement |
| 5,707,075 | Protecting apparatus |
| 5,709,724 | Process for fabricating a hermetic glass-to-metal seal |
| 5,711,546 | Hybrid inflator with coaxial chamber |
| 5,711,574 | Air bag-equipped child's vehicle seat and alarm/arming system therefore |
| 5,713,595 | Inflator for vehicular air bags |
| 5,719,351 | Anti-rupture method for liquid propellant gas inflator |
| 5,720,519 | Air bag-equipped child's vehicle seat and alarm/arming system therefor |
| 5,721,392 | Pyrotechnic ignition device |
| 5,725,245 | Diffuser plate for an airbag gas generator |
| 5,725,699 | Metal complexes for use as gas generants |
| 5,726,382 | Eutectic mixtures of ammonium nitrate and amino guanidine nitrate |
| 5,727,813 | Air bag inflator |
| 5,734,123 | Extrudable gas-generating compositions |
| 5,735,118 | Using metal complex compositions as gas generants |
| 5,738,374 | Pyrotechnic gas generator for inflatable air-bag of a motor vehicle |
| 5,741,465 | Reactive waste deactivation facility and method |
| 5,746,445 | Injection termination feature |
| 5,746,446 | Plastic film airbag |
| 5,747,696 | Method of non-invasively monitoring pressure of a compressed gas in a closed |
| | container |
| 5,747,730 | Pyrotechnic method of generating a particulate-free, non-toxic odorless and colorless |
| | gas |
| 5,752,717 | Inflatable metal bladders for automobile passenger protection |
| 5,755,457 | Air bag device |
| 5,756,929 | Nonazide gas generating compositions |
| 5,756,930 | Process for the preparation of gas-generating compositions |
| 5,762,369 | Air bag inflator using liquid monopropellant and adaptable to produce ouputs with |
| | various parameters |
| 5,763,027 | Insensitive munitions composite pressure vessels |
| 5,763,817 | Center gas fill inflator |
| 5,763,821 | Autoignition propellant containing superfine iron oxide |
| 5,765,867 | Air bag with externally mounted tether |
| 5,769,452 | Vehicle occupant protective air bag system |
| 5,772,239 | Airbag sub-module having fabric envelope with horn switch |
| 5,773,754 | Gas generating agent with trihydrazino triazine fuel |
| 5,779,261 | Vehicle air bag retaining arrangement |
| 5,779,263 | Integrated side impact air bag system within a seat structure |
| 5,779,269 | Propellant module assembly |
| 5,780,768 | Gas generating compositions |
| 5,782,486 | Rapid gas-fill apparatus and method |
| 5,782,487 | Gas generator |
| 5,783,773 | Low-residue azide-free gas generant composition |
| 5,787,563 | Method for assembling a compressed air bag inflator |
| 5,788,275 | Hybrid inflator |
| 5,791,340 | Resuscitator |
| 5,791,685 | Three-chambered side impact air bag |
| 5,792,976 | Rapidly deployable volume-displacement system for restraining movement of |
| | objects |
| 5,794,973 | Dual stage air bag inflator |
| 5,799,469 | Method for the manufacture and/or filling of a two-chamber pressure pack |
| 5,799,974 | Vehicle air bag system |
| 5,801,453 | Process for preparing spherical energetic compounds |
| 5,803,488 | Inflator retainer and air bag module |
| 5,806,885 | Ignition orifice in fluid fueled inflator |
| 5,806,886 | Device for abating carbon monoxide in airbags |
| 5,806,888 | Air bag inflator |
| 5,817,972 | Iron oxide as a coolant and residue former in an organic propellant |
| 5,821,448 | Compact hybrid inflator |
| 5,823,566 | Air bag module with deployment flap |
| 5,833,264 | Inflator assembly for a vehicle air bag system |
| 5,833,311 | Add-on child seat |
| 5,836,610 | Multiple level fluid fueled airbag inflator |
| 5,839,754 | Multiple stage airbag gas generator |
| 5,847,315 | Solid solution vehicle airbag clean gas generator propellant |
| 5,850,053 | Eutectic mixtures of ammonium nitrate, guanidine nitrate and potassium perchlorate |
| 5,851,027 | Variable output driver side hybrid inflator |
| 5,851,028 | Inflator with flow diverter and heat sink |
| 5,851,029 | Gas pressure restraint, sensing and release systems |
| 5,853,192 | Variable vented housing |
| 5,854,442 | Gas generator compositions |
| 5,856,710 | Inductively coupled energy and communication apparatus |
| 5,861,571 | Gas-generative composition consisting essentially of ammonium perchlorate plus a |
| | chlorine scavenger and an organic fuel |
| 5,863,068 | Plastic film airbag |
| 5,868,422 | Inflatabe metal bladders for automobile passenger protection |
| 5,868,424 | Substantially smoke-free and particulate-free inflator for inflatable safety restraint |
| | system |
| 5,872,329 | Nonazide gas generant compositions |
| 5,876,060 | Seat mounted side impact module |
| 5,884,939 | Air bag system for automotive passenger seat |
| 5,890,736 | Aspiration-type air bag inflation apparatus |
| 5,893,579 | Seat mounted air bag system |
| 5,895,070 | Side impact air bag system |
| 5,899,485 | Air bag module with simplified manifold |
| 5,899,488 | Air bag arrangement and triggering process therefor |
| 5,899,494 | Deflagration venting system for airbag systems |
| 5,904,366 | Air bag apparatus |
| 5,904,369 | Catalytically plated air bag |
| 5,907,120 | Inflator for vehicle air bags |
| 5,912,427 | Semiconductor bridge explosive device |
| 5,918,900 | Hybrid inflator with bore and burst disk |
| 5,920,029 | Igniter assembly and method |
| 5,924,727 | Inflator assembly for a vehicle air bag system |
| 5,931,495 | Ignition system for a fluid-fueled inflator |
| 5,931,499 | Vehicle stabilizing apparatus |
| 5,934,705 | Two chamber inflator body |
| 5,934,743 | Impact absorbing outer body structure of a motor vehicle |
| 5,938,233 | Air bag device |
| 5,938,235 | Hybrid inflator |
| 5,939,795 | Seat sensor operating safety system for a motor vehicle |
| 5,944,343 | Miniature inflator |
| 5,947,510 | Air bag module |
| 5,947,514 | Valve controlled automotive pyrotechnic systems |
| 5,951,040 | Air bag inflator with pressure regulation |
| 5,951,042 | Vehicle occupant protection apparatus |
| 5,951,043 | Air bag inflator using liquid monopropellant and adaptable to produce outputs with |
| | various parameters |
| 5,962,803 | Apparatus for preparing spherical energetic compounds |
| 5,962,808 | Gas generant complex oxidizers |
| 5,967,550 | Staged pyrotechnic air bag inflator |
| 5,970,703 | Metal hydrazine complexes used as gas generants |
| 5,976,293 | Method for making a case for combustible materials |
| 5,979,328 | Vehicular impact signaling device |
| 5,984,351 | Dual stage actuation system |
| 5,984,352 | Air bag inflator with pressure regulation |
| 5,988,069 | Electric initiator having a sealing material forming a ceramic to metal seal |
| 5,988,438 | Apparatus for rapid inflation of inflatable object and related method |
| 5,997,666 | GN, AGN and KP gas generator composition |
| 6,000,718 | End cap assembly for airbag inflator |
| 6,004,410 | Apparatus comprising an inflatable vehicle occupant protection device and a gas |
| | generating composition therefor |
| 6,009,809 | Bridgewire initiator |
| 6,012,737 | Vehicle occupant protection apparatus |
| 6,017,404 | Nonazide ammonium nitrate based gas generant compositions that burn at ambient |
| | pressure |
| 6,019,389 | Air bag inflator |
| 6,019,390 | Multiple panel airbag |
| 6,020,655 | Control circuit for an airbag release unit |
| 6,029,558 | Reactive personnel protection system |
| 6,029,932 | Detonating valve for releasing openings of air bag landing systems |
| 6,036,226 | Inflator capable of modulation air bag inflation rate in a vehicle occupant restraint |
| | apparatus |
| 6,039,347 | Liquid propellant airbag inflator with dual telescoping pistons |
| 6,039,348 | Variable output inflator with adaptive heat sinking |
| 6,039,820 | Metal complexes for use as gas generants |
| 6,042,147 | Air-bag device |
| 6,045,638 | Monopropellant and propellant compositions including mono and |
| | polyaminoguanidine dinitrate |
| 6,047,541 | HAN TEAN (xm-46) mixing gas generator propellant tank pressurizer for launch |
| | vehicles and spacecraft |
| 6,050,598 | Apparatus for and method of monitoring the mass quantity and density of a fluid in a |
| | closed container, and a vehicular air bag system incorporating such apparatus |
| 6,053,110 | Airbag generant wafer design with I-beam construction |
| 6,053,270 | Steering angle correcting system in vehicle |
| 6,059,906 | Methods for preparing age-stabilized propellant compositions |
| 6,062,142 | Autoignition system for inflator devices with separator that melts |
| 6,062,143 | Distributed charge inflator system |
| 6,065,773 | Gas pressure restraint, sensing and release systems |
| 6,068,287 | Electronic device and method for actuating a passenger-protection system |
| 6,073,438 | Preparation of eutectic mixtures of ammonium nitrate and amino guanidine nitrate |
| 6,073,961 | Inflatable side airbag curtain module |
| 6,073,963 | Initiator with injection molded insert member |
| 6,074,502 | Smokeless gas generant compositions |
| 6,076,468 | Solid propellant/water type hybrid gas generator |
| 6,079,739 | Pyrotechnic gas generator with an adaptable flow rate for air bags |
| 6,086,095 | Airbag cushion exhibiting low seam and fabric usage and simultaneously high |
| | available inflation volume |
| 6,093,269 | Pyrotechnic gas generant composition including high oxygen balance fuel |
| 6,095,558 | Gas generator made of metal sheets for protective devices of motor vehicles |
| | passengers |
| 6,095,561 | Multi-chamber inflator |
| 6,099,033 | Compressed air bag inflator |
| 6,106,038 | System for collision damage reduction |
| 6,109,647 | Seat-occupant restraining apparatus |
| 6,116,641 | Dual level gas generator |
| 6,117,255 | Gas generating composition comprising guanylurea dinitramide |
| 6,120,058 | Air bag inflator |
| 6,120,626 | Dispensing fibrous cellulose material |
| 6,123,359 | Inflator for use with gas generant compositions containing guanidines |
| 6,123,790 | Nonazide ammonium nitrate based gas generant compositions that burn at ambient |
| | pressure |
| 6,126,197 | Lightweight discoidal filterless air bag inflator |
| 6,131,949 | Venting systems for inflatables |
| 6,139,054 | Reduced smoke gas generant with improved temperature stability |
| 6,142,056 | Variable thrust cartridge |
| 6,142,508 | Side impact air bag system |
| 6,142,511 | Inflatable passenger restraint and inflator therefor |
| 6,142,515 | Air bag inflator with heat sink and retainer |
| 6,142,518 | Dual inflator apparatus including pyrotechnic inflator |
| 6,143,103 | Gas generating material for vehicle occupant protection device |
| 6,145,876 | Vehicle inflator with stored gas for supplementing inflation |
| 6,149,184 | Simplified driver side air bag assembly |
| 6,149,194 | Plastic film airbag |
| 6,155,600 | Safety air bag inflation device |
| 6,156,137 | Gas generative compositions |
| 6,156,230 | Metal oxide containing gas generating composition |
| 6,165,295 | Gas-generating liquid compositions (PERSOL 1) |
| 6,170,594 | Method and apparatus for reducing vehicle rollover |
| 6,170,868 | Hybrid inflator |
| 6,176,517 | Gas generating apparatus |
| 6,176,950 | Ammonium nitrate and paraffinic material based gas generating propellants |
| 6,179,326 | Efficient airbag system |
| 6,182,782 | Device for reducing the impact of pedestrians |
| 6,186,540 | Method of filling an empty, flexible container, and a container device |
| 6,186,541 | Air bag arrangement with gas filtration |
| 6,186,543 | Air bag system for automotive passenger seat |
| 6,189,919 | Steering column arrangement for occupant protection |
| 6,189,922 | Inflator with multiple initiators |
| 6,196,577 | Air bag apparatus |
| 6,196,581 | Airbag inflator and an airbag apparatus |
| 6,196,582 | Variable output inflator for an air bag |
| 6,196,583 | Gas generator with cooling device |
| 6,199,900 | Vehicle safety collision headrest system |
| 6,199,905 | High thermal efficiency inflator and passive restraints incorporating same |
| 6,203,061 | Variable output air bag module with PAV heat sink |
| 6,210,505 | High gas yield non-azide gas generants |
| 6,213,496 | Airbag device with inner and outer bags |
| 6,213,502 | Air bag module with variable inflation |
| 6,214,138 | Ignition enhancer composition for an airbag inflator |
| 6,217,067 | Flame protection for a gas bag |
| 6,218,577 | Enegetic hydrazinium salts |
| 6,220,309 | Inflatable fabrics comprising basket-woven attachment points between fabric panels |
| 6,220,626 | Air belt apparatus |
| 6,224,097 | Inflator for inflatable restraint |
| 6,224,099 | Supplemental-restraint-system gas generating device with water-soluble polymeric |
| | binder |
| 6,224,100 | Air bag apparatus, air bag folding method, and air-bag folding device |
| 6,227,565 | Air bag inflator with pressure regulation |
| 6,227,566 | Airbag device with inflator |
| 6,228,191 | Gas-generating preparation with iron and/or copper carbonate |
| 6,230,491 | Gas-generating liquid compositions (persol 1) |
| 6,230,501 | Ergonomic systems and methods providing intelligent adaptive surfaces and |
| | temperature control |
| 6,234,523 | Dual type inflator device wherein light-emitting phenomenon is suppressed |
| 6,235,132 | Gas generating compositions |
| 6,237,941 | Inflatable side airbag curtain module |
| 6,237,950 | Staged air bag inflator |
| 6,237,951 | Device for letting pressurized gas stream into a safety device |
| 6,241,281 | Metal complexes for use as gas generants |
| 6,247,726 | Air bag module with variable inflation |
| 6,250,668 | Tubular airbag, method of making the same and occupant protection system |
| | including the same |
| 6,254,164 | Vehicle occupant protection system |
| 6,257,527 | Hypersonic and orbital vehicles system |
| 6,257,617 | Air bag inflator with pressure regulation |
| 6,266,926 | Gas generator deployed occupant protection apparatus and method |
| 6,270,113 | Side air bag system |
| 6,274,064 | Metal oxide containing gas generating composition |
| 6,274,252 | Hermetic glass-to-metal seal useful in headers for airbags |
| 6,277,221 | Propellant compositions with salts and complexes of lanthanide and rare earth |
| | elements |
| 6,283,543 | Motor vehicle roof |
| 6,287,400 | Gas generant composition |
| 6,290,256 | Air bag inflator with pressure regulation |
| 6,293,581 | Occupant restraint device |
| 6,293,582 | Control system for air bags in different vehicle locations |
| 6,294,487 | Airbag fabric processing very low cover factor |
| 6,296,274 | Apparatus for inflating a side curtain |
| 6,298,787 | Non-lethal kinetic energy weapon system and method |
| 6,299,203 | Airbag device in a vehicle and method for activating an airbag device |
| 6,299,204 | Vehicle restraint system comprising an airbag having an integrated mouth |
| 6,299,205 | Vehicle restraint system comprising an airbag having a looped pocket for inflation |
| | canister disposition |
| 6,299,206 | Vehicle restraint system comprising an airbag having an integrated mouth |
| 6,299,711 | Gas-generating liquid compositions (OXSOL 3) |
| 6,299,965 | Inflatable fabrics comprising peel seams which become shear seams upon inflation |
| 6,306,232 | Thermally stable nonazide automotive airbag propellants |
| 6,314,887 | Microelectromechanical systems (MEMS)-type high-capacity inertial-switching |
| | device |
| 6,315,322 | Air bag inflator |
| 6,315,847 | Water-free preparation of igniter granules for waterless extrusion processes |
| 6,315,930 | Method for making a propellant having a relatively low burn rate exponent and high |
| | gas yield for use in a vehicle inflator |
| 6,325,408 | Air bag attachment arrangement |
| 6,328,830 | Metal oxide-free 5-aminotetrazole-based gas generating composition |
| 6,328,831 | Gas-generating liquid compositions (Perhan) |
| 6,328,906 | Chemical delivery systems for fire suppression |
| 6,331,220 | Gas-generating liquid compositions (PERSOL 2) |
| 6,334,917 | Propellant compositions for gas generating apparatus |
| 6,334,961 | Low ash gas generant and ignition compositions for vehicle occupant passive |
| | restraint systems |
| 6,336,657 | Seat-occupant restraining apparatus |
| 6,340,175 | Air bag assemblies with foamed energetic igniters |
| 6,341,562 | Initiator assembly with activation circuitry |
| 6,343,812 | Method for fixing an adjustable automobile steering column and device for carrying |
| | out the method |
| 6,352,030 | Gas generating eject motor |
| 6,361,064 | Inflator seal retainer for an air bag module |
| 6,361,631 | Liquid monopropellants for passive vehicle occupant restraint systems |
| 6,363,307 | Control system for occupant protection apparatus |
| 6,364,350 | Motor vehicle occupant safety device |
| 6,364,353 | Dual stage air bag inflator |
| 6,364,356 | Airbag cushion comprising sewn reinforcement seams |
| 6,364,975 | Ammonium nitrate propellants |
| 6,368,431 | Air bag inflator |
| 6,371,517 | Adaptive inflation mechanism |
| 6,373,384 | Inflatable security device |
| 6,375,219 | Airbag cushion exhibiting low fabric usage and simultaneously high available |
| | inflation volume |
| 6,379,627 | Gas generator |
| 6,382,660 | Air bag assembly |
| 6,400,145 | Seat belt tension sensor, methods of integration and attachment |
| 6,402,191 | Inflatable air bag system which serves as a protective wall in front of a vehicle |
| | sidewall |
| 6,409,213 | Adaptive inflation mechanism |
| 6,409,214 | Airbag inflator and an airbag apparatus |
| 6,412,391 | Reactive personnel protection system and method |
| 6,416,600 | Process for the production of an exothermically reacting composition |
| 6,417,579 | Electrical system with security battery disconnection |
| 6,418,870 | Torpedo launch mechanism and method |
| 6,419,262 | Occupant protective device located in the steering wheel of a motor vehicle |
| 6,422,601 | Dual chamber inflator |
| 6,425,601 | Air bag module |
| 6,427,599 | Pyrotechnic compositions and uses therefore |
| 6,428,041 | Airbag system for a motor vehicle |
| 6,431,582 | Simplified driver side air bag assembly |
| 6,431,594 | Air bag inflator with mechanism for deactivation of second stage and autoignition |
| 6,431,597 | Reduced smoke gas generant with improved mechanical stability |
| 6,435,552 | Method for the gas-inflation articles |
| 6,439,603 | Air bag module with variable inflation |
| 6,447,007 | Compact dual nozzle air bag inflator |
| 6,450,529 | Inflatable side air bag curtain module with chamber separators |
| 6,450,573 | Anti-submarine vehicle seat device |
| 6,454,299 | Airbag device |
| 6,454,306 | Gas generator for seat belt pretensioner |
| 6,454,887 | Gas generant for air bag |
| 6,457,741 | Seat mounted side air bag |
| 6,464,253 | Vehicular restraint system |
| 6,472,033 | Airbag cushion exhibiting low seam usage and simultaneously high available |
| | inflation volume |
| 6,472,352 | Aqueous lubricant and process for cold forming metal, with improved formed |
| | surface quality |
| 6,474,684 | Dual stage inflator |
| 6,475,312 | Method of formulating a gas generant composition |
| 6,477,957 | Ignition device for a safety system |
| 6,478,329 | Air bag |
| 6,481,746 | Metal hydrazine complexes for use as gas generants |
| 6,481,747 | Cool, low effluent pyrotechnic inflator |
| 6,485,403 | Air bag system of folding an air bag |
| 6,485,588 | Autoignition material additive |
| 6,487,974 | Inflator |
| 6,488,310 | Hybrid inflator |
| 6,489,006 | Inflatable fabrics comprising peel seams which become shear seams upon inflation |
| 6,497,429 | Airbag apparatus |
| 6,497,774 | Gas generant for air bag |
| 6,508,894 | Insensitive propellant formulations containing energetic thermoplastic elastomers |
| 6,511,094 | Automotive vehicle air bag system |
| 6,513,602 | Gas generating device |
| 6,513,834 | Monopropellant smokeless gas generant materials |
| 6,513,835 | Automotive vehicle air bag system |
| 6,513,880 | Power actuator suitable for vehicle occupant restraint systems |
| 6,523,855 | Air bag, method of manufacture and system therefor |
| 6,530,543 | Hypersonic and orbital vehicles system |
| 6,533,316 | Automotive electronic safety network |
| 6,533,318 | Air bag system for automotive passenger seat |
| 6,536,798 | Controlling activation of restraint devices in a vehicle |
| 6,539,869 | Heat transfer initiator |
| 6,543,805 | Dual stage air bag inflator |
| 6,547,275 | Air bag gas generator and air bag device |
| 6,547,277 | Two chamber gas generator |
| 6,556,119 | High current intensity fuse device |
| 6,557,474 | Initiator header subassembly for inflation devices |
| 6,560,832 | Structurally efficient airbag cushion exhibiting high available inflation volume |
| 6,566,869 | Seat belt tension sensor, methods of integration and attachment |
| 6,568,703 | Interference fit attachment for a rounded member |
| 6,572,136 | Automotive air bag system |
| 6,572,144 | Airbag |
| 6,574,962 | KOH flue gas recirculation power plant with waste heat and byproduct recovery |
| 6,581,963 | Catalytic filter for an inflator |
| 6,581,964 | Gas bag module |
| 6,584,911 | Initiators for air bag inflators |
| 6,585,290 | Diffuser for an air bag |
| 6,595,102 | Reactive personnel protection system and method |
| 6,595,244 | Inflatable fabrics having woven attachment points between fabric panels |
| 6,595,548 | Air bag system, method of folding air bag and air bag folding apparatus |
| 6,598,899 | Inflatable seat belt using MEMS devices |
| 6,598,901 | Gas generator for air bag and air bag apparatus |
| 6,598,902 | Welded airbag cushion comprising sewn reinforcement seams |
| 6,601,872 | Compact multi-level inflator |
| 6,604,599 | Anti-submarine vehicle occupant restraint system |
| 6,605,233 | Gas generant composition with coolant |
| 6,607,213 | Gas generating device for air bag and air bag inflating method |
| 6,612,243 | Fire extinguisher |
| 6,612,610 | Air bag device |
| 6,619,692 | Air bag inflators |
| 6,623,033 | Airbag inflation control system and method |
| 6,626,455 | Deformable air bag module housing |
| 6,626,457 | Curtain airbag |
| 6,629,575 | Vehicle occupant emergency system |
| 6,640,721 | Non-lethal airbag munition |
| 6,641,074 | Seat belt webbing pretensioner using MEMS devices |
| 6,644,206 | Electrically actuatable initiator with output charge |
| 6,648,366 | Driver side air bag with particulate diverter |
| 6,648,367 | Integrated occupant protection system |
| 6,650,528 | Ignition device for a safety system |
| 6,659,500 | Multi-chamber inflator |
| 6,666,934 | Extruded hydroxy terminated polybutadiene gas generating material |
| 6,669,226 | Air bag module with oppositely aligned inflators |
| 6,669,229 | Automotive vehicle air bag system |
| 6,669,231 | Adaptive venting for an air bag module |
| 6,672,220 | Apparatus and method for dispersing munitions from a projectile |
| 6,672,618 | Multiple panel airbag and method |
| 6,673,172 | Gas generant compositions exhibiting low autoignition temperatures and methods of |
| | generating gases therefrom |
| 6,673,728 | Low permeability, high strength timing fabric for utilization within airbag inflation |
| | modules |
| 6,679,522 | Airbag |
| 6,688,231 | Cord-type gas generator |
| 6,688,555 | Anti-hijacking system |
| 6,695,259 | Communication system, communication receiving device and communication |
| | terminal in the system |
| 6,701,849 | Dual stage air bag inflator with secondary propellant cap |
| 6,702,323 | Air bag module with pressure regulator |
| 6,705,637 | Inflator |
| 6,709,006 | Air bag device |
| 6,713,412 | Low permeability, high strength timing fabric for utilization within airbag inflation |
| | modules |
| 6,715,371 | Method of testing an airbag module |
| 6,715,790 | Side curtain air bag |
| 6,718,884 | Initiator assembly |
| 6,719,323 | Air bag apparatus and steering wheel |
| 6,726,788 | Preparation of strengthened ammonium nitrate propellants |
| 6,733,036 | Automotive electronic safety network |
| 6,739,362 | Hybrid-gas generator, in particular for filling a gas bag |
| 6,746,044 | Actuatable fastener for air bag module vent |
| 6,749,218 | Externally deployed airbag system |
| 6,755,273 | Combined airbag inflation and occupant displacement enabling method and |
| | apparatus |
| 6,758,199 | Tuned power ignition system |
| 6,764,096 | Dual chamber inflator |
| 6,767,030 | Air bag system for automotive passenger seat |
| 6,779,464 | Gas generating composition |
| 6,789,702 | System for dispensing multi-component products |
| 6,789,820 | Variable output inflator |
| 6,793,244 | Multi-stage expansion tire hybrid inflator |
| 6,796,579 | Gas generator with airbag device |
| 6,799,776 | Hybrid inflator |
| 6,805,376 | Inflator with shock wave generator |
| 6,805,377 | Inflator |
| 6,805,380 | Vehicular passive safety device |
| 6,808,204 | Hybrid inflator |
| 6,823,244 | Vehicle part control system including electronic sensors |
| 6,823,645 | Radial tube air bag folding apparatus and method |
| 6,834,885 | Inflator |
| 6,835,102 | Connector provided with front holder |
| 6,837,517 | Multiple panel airbag and method |
| 6,843,503 | Controlled venting apparatus and method therefor |
| 6,851,709 | Multistage-inflating type hybrid inflator |
| 6,854,762 | Airbag system |
| 6,860,510 | Multistage inflating-type hybrid inflator |
| 6,860,511 | Multiple chamber dual stage inflator |
| 6,860,951 | Gas generating compositions |
| 6,863,303 | Hybrid inflator |
| 6,865,825 | Ergonomic systems and methods providing intelligent adaptive surfaces and |
| | temperature control |
| 6,871,871 | Air bag inflator |
| 6,874,544 | System for dispensing multi-component products |
| 6,877,435 | Dual-stage gas generator utilizing eco-friendly gas generant formulation |
| 6,877,698 | Aircraft evacuation slide inflation system using a stored liquified gas capable of |
| | thermal decomposition |
| 6,883,827 | Modular air bag cushion system |
| 6,886,469 | Distributed charge inflator system |
| 6,887,326 | Nonazide gas generant compositions |
| 6,889,613 | Variable output inflator |
| 6,889,614 | Air bag inflator |
| 6,892,983 | Anti-hijacking system |
| 6,905,135 | Inflator system |
| 6,908,149 | Anti-submarine vehicle seat device |
| 6,910,713 | Airbag cushion exhibiting low fabric usage and simultaneously high available |
| | inflation volume |
| 6,913,319 | Power actuator |
| 6,913,661 | Ammonium nitrate propellants and methods for preparing the same |
| 6,918,340 | Dual-stage gas generator utilizing eco-friendly gas generant formulation for military |
| | applications |
| 6,918,459 | Method and apparatus for deploying airbags |
| 6,918,611 | System and method for controlling an inflatable cushion |
| 6,918,976 | Gas generating composition |
| 6,923,342 | Systems for dispensing multi-component products |
| 6,926,303 | Inflatable vehicle occupant protection device with inflation fluid deflector |
| 6,926,792 | Method of fabricating an air-bag and an air-bag fabricated by the method |
| 6,936,303 | Electric type initiator and gas generator |
| 6,945,559 | Method and apparatus for air bag venting |
| 6,951,317 | Vehicle, lightweight pneumatic pilot valve and related systems therefor |
| 6,953,823 | Elastomeric insulating composition for a solid propellant rocket motor |
| 6,962,113 | Segmented-rod warhead |
| 6,962,363 | Multiple chamber airbags and methods |
| 6,966,373 | Inflatable sealing assembly and method for sealing off an inside of a flow carrier |
| 6,969,435 | Metal complexes for use as gas generants |
| 6,979,022 | Flexible inflator with co-extruded propellant and moisture barrier |
| 6,979,024 | Gas generator for seat belt pretensioner |
| 6,983,955 | Air bag inflators |
| 6,988,026 | Wireless and powerless sensor and interrogator |
| 6,991,254 | Airbag system |
| 6,997,477 | Inflator |
| 7,004,074 | Controlled fluid energy delivery burst cartridge |
| 7,007,972 | Method and airbag inflation apparatus employing magnetic fluid |
| 7,017,944 | Multiple chamber inflator |
| 7,025,378 | Air bag and method for making an air bag |
| 7,042,696 | Systems and methods using an electrified projectile |
| 7,048,304 | Multiple panel airbag and method |
| 7,052,041 | Gas generator and gas generant packet used therein |
| 7,057,872 | Systems and methods for immobilization using selected electrodes |
| 7,059,633 | Hybrid gas inflator |
| 7,059,635 | Hybrid inflator |
| 7,069,961 | Inflatable fabrics comprising basket-woven attachment points between fabric panels |
| 7,070,204 | Programmable gas generator using microcells |
| 7,073,820 | Inflator |
| 7,080,854 | Pyrotechnic linear inflator |
| 7,080,855 | Safety steering column, motor vehicle with a safety system and safety method |
| 7,082,359 | Vehicular information and monitoring system and methods |
| 7,089,099 | Sensor assemblies |
| 7,097,203 | Inflator |
| 7,103,460 | System and method for vehicle diagnostics |
| 7,104,569 | Air bag module with pressure regulator |
| 7,107,706 | Ergonomic systems and methods providing intelligent adaptive surfaces and |
| | temperature control |
| 7,111,871 | Automotive vehicle air bag system |
| 7,114,744 | Airbag apparatus and related method |
| 7,114,874 | Security barrier |
| 7,118,129 | Air bag system for automotive passenger seat |

TABLE II
FIRE SUPPRESSOR APPARATUSES AND MEHTODS

| Publication | |
|---|---|
| Number | Title |
| 20020023967 | Effervescent liquid fine mist apparatus and method |
| 20020070035 | Method and system for extinguishing fire in an enclosed space |
| 20020139542 | Process and installation for fighting a fire in an aircraft compartment and aircraft |
| | equipped with such an installation |
| 20020144824 | Microemulsion mists as fire suppression agents |
| 20030006046 | Fire extinguishing ball |
| 20030019641 | Fire suppression system and method for an interior area of an aircraft lavatory |
| | waste container fire protection |
| 20030051886 | Fire suppression using water mist with ultrafine size droplets |
| 20030062173 | Method of fire extinguishment with gas and fire-extinguising equipment |
| 20030062175 | Fire suppression system and solid propellant aerosol generator for use therein |
| 20030141082 | Portable breathable fire extinguishing liquefied gas delivery system |
| 20030150623 | Fire extinguishing spray nozzle |
| 20030155134 | Fire blanket |
| 20030205390 | Method and apparatus for distributing granular material |
| 20040016551 | Methods and apparatus for extinguishing fires |
| 20040020665 | Helium gas total flood fire suppression system |
| 20040020666 | Explosion suppression system |
| 20040045725 | Retrofitted non-halon fire suppression system and method of retrofitting existing |
| | halon based systems |
| 20040069505 | Method and apparatus to extinguishing fire in areas beyond the reach of standard |
| | fire equipments |
| 20040089460 | System and method for suppressing fires |
| 20040129435 | Flame suppression agent, system and uses |
| 20040140105 | Combustion supression system |
| 20040163826 | Fire protection systems and methods |
| 20040188103 | Thermally activated fire suppression system |
| 20040194974 | Pressurization system for fire extinguishers |
| 20040194977 | Self-modulating inert gas fire suppression system |
| 20040226726 | Vehicle fire extinguisher |
| 20040262018 | Fire extinguishing cover |
| 20050016741 | Fire extinguishing system for large structures |
| 20050023007 | Methods using fluoroketones for: extinguishing fire; preventing fire; and |
| | reducing or eliminating the flammability of a flammable working fluid |
| 20050051345 | Fire blanket |
| 20050077054 | Methods and apparatus for extinguishing fires |
| 20050115722 | Method and apparatus for suppression of fires |
| 20050139363 | Fire suppression delivery system |
| 20050139365 | System and method for suppressing fires |
| 20050139366 | Method and apparatus for extinguishing a fire in an enclosed space |
| 20050139367 | Fire extinguishing device and method |
| 20050150663 | Fire extinguishing device |
| 20050178566 | Fire extinguisher with means for preventing freezing at outlet |
| 20050183869 | Fire-suppression system for an aircraft |
| 20050189123 | System and method for suppressing fires |
| 20050217871 | Fire suppression system and method for an interior area of an aircraft lavatory |
| | waste container fire protection |
| 20050257937 | Device for extinguishing fire by injection of a gas generated by the combustion of |
| | a pyrotechnic block |
| 20050263299 | Fire extinguishing method by gas and extingushing device |
| 20060011356 | Fire-resistant tent for building structures |
| 20060076430 | Methods and systems for simulating multi-phase fluid flows, including fire |
| | suppressant flows |
| 20060175429 | Fire fighting system |
| 20060196681 | Fire Suppression Using Water Mist with Ultrafine Size Droplets |
| 20060201687 | Self-contained automated residential fire extinguisher |
| 20060213673 | Method of preventing fire in computer room and other enclosed facilities |
| 20060231270 | Automotive Fire Suppression System With Dynamic Reservoir Seal |
| 3,930,541 | Flame prevention system for fuel tank fires |
| 3,952,809 | Series to parallel transfer circuit for initiator string |
| 3,964,390 | Bursting disc assembly |
| 3,965,988 | Fire extinguishing method and apparatus |
| 3,967,255 | Flame detection system |
| 3,980,139 | Fire extinguishing bomb for putting out fires |
| 3,986,560 | Fire protection means |
| 3,990,516 | Pneumatic time delay valve |
| 4,006,780 | Rupturing head for fire extinguishers |
| 4,013,128 | Modular fire protection system |
| 4,020,904 | Dispersion nozzle with removable dispersion element |
| 4,020,905 | Construction of fire extinguishers |
| 4,046,156 | Explosion discharge valve |
| 4,055,844 | Detection system |
| 4,064,944 | Apparatus for fire extinguishing system for floating-roof tanks |
| 4,069,873 | Apparatus for fire extinguishing system for floating-roof tanks |
| 4,073,464 | Cylinder valve for gas fire extinguishing system |
| 4,082,148 | Fire protection system |
| 4,090,567 | Fire fighting helicopter |
| 4,109,726 | Gas fire extinguishing system |
| 4,110,812 | Non-recurrent pulse generator |
| 4,121,666 | Fuel (flammable liquid) tank fire extinguisher |
| 4,126,184 | Instantaneous release, dual valve for fire suppression apparatus |
| 4,129,185 | Fire suppression system |
| 4,132,271 | Fragment prevention screen for explodable fire suppressant panels |
| 4,159,744 | Fire extinguishant mechanism |
| 4,183,409 | Automatic fire-extinguishing system |
| 4,188,856 | Compressed-gas-actuated switching device |
| 4,194,571 | Fire suppression mechanism for military vehicles |
| 4,199,029 | Multiple, independently actuatable fire suppression devices each having |
| | individual actuating power source |
| 4,201,178 | Engine flameproofing |
| 4,213,567 | Discharge nozzle for fluorinated hydrocarbon fire suppression system |
| 4,217,959 | Electrically controlled fluid disperser for a fire extinguishing system |
| 4,232,742 | Flame-guard for electrical installations |
| 4,262,749 | Fire suppression bladder system for fuel tanks |
| 4,263,971 | Fire and explosion suppression apparatus |
| 4,267,890 | Fire extinguishing system including sensor comparable to determine charge |
| 4,270,613 | Fire and explosion detection and suppression system |
| 4,275,860 | Full span shipboard fueling system for aircraft |
| 4,281,717 | Expolosion suppression system for fire or expolosion susceptible enclosures |
| 4,285,403 | Explosive fire extinguisher |
| 4,289,207 | Fire extinguishing system |
| 4,296,817 | Fire suppression system for military tanks |
| 4,305,469 | Fire extinguishing system having a discharge valve and a distribution valve |
| | actuated by a pneumatic actuator |
| 4,319,640 | Gas generator-actuated fire suppressant mechanism |
| 4,328,867 | Fire extinguishers |
| 4,328,868 | Fire suppressant impact diffuser |
| 4,332,368 | Valve |
| 4,347,901 | Fire extinguishing system for aircraft |
| 4,351,394 | Method and system for aircraft fire protection |
| 4,390,069 | Trifluorobromomethane foam fire fighting system |
| 4,394,868 | Horizontal discharge assembly for vertically oriented fire extinguisher |
| 4,411,318 | Fire-extinguishing waste receptacle |
| 4,420,047 | Stowable fire suppression system for aircraft cabins and the like |
| 4,436,159 | Manual/electric activated squib actuated discharge valve for fire extinguishers |
| 4,462,319 | Method and apparatus for safely controlling explosions in black liquor recovery |
| | boilers |
| 4,487,266 | Explosion suppression apparatus |
| 4,488,603 | A compact and highly mobile fire-fighting vehicle |
| 4,499,952 | Fire and explosion detection and suppression system and actuation circuitry |
| | therefor |
| 4,520,871 | Fire extinguishing system |
| 4,531,588 | Fire suppression system |
| 4,532,996 | Automatic fire extinguisher with acoustic alarm |
| 4,567,948 | Fire extinguisher valve |
| 4,569,399 | Safety enclosure |
| 4,577,544 | Ultrafast thermal actuator |
| 4,580,638 | Fire suppression and control system |
| 4,583,597 | Fire and explosion detection and suppression system |
| 4,589,496 | Fire suppressant valve using a floating poppet |
| 4,592,301 | Fire extinguisher support mechanism incorporating an audible alarm |
| 4,597,451 | Fire and explosion detection and suppression |
| 4,606,832 | Fire extinguishing composition |
| 4,616,694 | Fireproof cabinet system for electronic equipment |
| 4,617,174 | Automatic autonomous apparatus for the fast production of polyurethane foam |
| 4,622,209 | Process and apparatus for reducing the chances of ignition and explosion due to |
| | the decomposition of high-pressure industrial process gases |
| 4,625,808 | Device for coupling fire extinguishers to closed-off compartments |
| 4,630,684 | Fire sensing and suppression method and system responsive to optical radiation |
| | and mechanical wave energy |
| 4,633,967 | Circumbendibus safety system for a vehicle |
| 4,637,472 | Rapid discharge extinguisher |
| 4,637,473 | Fire suppression system |
| 4,643,260 | Fire suppression system with controlled secondary extinguishant discharge |
| 4,645,009 | Method and means for producing and dispensing extinguishing fluids |
| 4,646,848 | Fire suppression system for an aircraft |
| 4,650,003 | Light path heat detector |
| 4,662,454 | Foam extinguishing system |
| 4,664,199 | Method and apparatus for extinguishing fires in flammable liquid filled storage |
| | vessels |
| 4,668,407 | Fire extinguishing composition and method for preparing same |
| 4,676,319 | Fire fighting tool and method |
| 4,691,783 | Automatic modular fire extinguisher system for computer rooms |
| 4,693,320 | Fire suppression test apparatus |
| 4,697,643 | Temperature-compensated pressure controller, operationally reliable extinguisher |
| | provided with such a pressure controller and process for filling such a pressure |
| | controller |
| 4,702,322 | Explosion suppression system |
| 4,709,763 | Self-activating fire extinguisher |
| 4,711,307 | Compact self-contained fire extinguisher |
| 4,718,497 | Fire and explosion detection and suppression |
| 4,719,973 | Fire and explosion detection and suppression |
| 4,726,426 | Fire extinguishment system for an aircraft passenger cabin |
| 4,729,434 | Portable fire-fighting apparatus |
| 4,760,886 | Fast discharge fire extinguisher and a method of fabricating same |
| 4,763,731 | Fire suppression system for aircraft |
| 4,779,683 | Discharge control head for aircraft fire extinguishant containers |
| 4,805,701 | Fire extinguisher and alarm apparatus |
| 4,815,541 | Fire extinguisher |
| 4,826,610 | Fire extinguishant |
| 4,830,114 | Self-activating fire extinguisher |
| 4,830,116 | Fire extinguishing system |
| 4,830,762 | Method for fire extinguishment of liquid chlorosilane compound |
| 4,834,187 | Explosion suppression system |
| 4,854,388 | Fire extinguishing apparatus |
| 4,854,389 | Linear fire extinguisher |
| 4,856,762 | Fire retardant gas spring assembly for a passenger seat control |
| 4,889,189 | Fire suppressant mechanism and method for sizing same |
| 4,893,680 | Fire suppression activator |
| 4,895,208 | Elevator cab fire extinguishing system |
| 4,899,826 | Combination fire extinguisher and tire sealer |
| 4,938,293 | Linear fire extinguisher |
| 4,951,755 | Manual actuator |
| 4,953,623 | Protected L-shaped environment using single chemical nozzle |
| 4,953,624 | Cylinder pressure switch for automatic fire protection systems |
| 4,954,271 | Non-toxic fire extinguishant |
| 4,964,469 | Device for broadcasting dry material by explosive force |
| 4,970,936 | Gas reservoir actuation device |
| 4,986,366 | Method and apparatus for suppressing explosions and fires |
| 4,989,675 | Spray nozzle for fire control |
| 4,991,657 | Fire suppression system |
| 5,014,790 | Method and apparatus for fire control |
| 5,016,715 | Elevator cab fire extinguishing system |
| 5,018,586 | Fire suppression system for a decorative tree |
| 5,031,701 | Suppressant discharge nozzle for explosion protection system |
| 5,036,924 | Container fire nozzle hole adapter |
| 5,038,866 | Powder discharge apparatus |
| 5,040,609 | Fire extinguishing composition and process |
| 5,050,683 | Extinguishing rocket/missile solid propellants |
| 5,052,493 | Fire suppression systems for vehicles |
| 5,053,147 | Methods and compositions for extinguishing fires |
| 5,062,486 | Firefighter's barrier penetrator and agent injector |
| 5,069,291 | Method and apparatus for suppressing explosions and fires and preventing |
| | reignition thereof |
| 5,088,560 | Zero force fire extinguisher |
| 5,090,482 | Method and apparatus for extinguishing fires |
| 5,093,013 | Ozone friendly fire-extinguishing agents |
| 5,099,976 | Fire extinguishing apparatus for compressors |
| 5,102,557 | Fire extinguishing agents for streaming applications |
| 5,113,947 | Fire extinguishing methods and compositions utilizing 2-chloro-1,1,1,2- |
| | tetrafluoroethane |
| 5,115,867 | Dual linear fire extinguisher |
| 5,115,868 | Fire extinguishing composition and process |
| 5,119,877 | Explosion suppression system |
| 5,119,878 | Impact activated vehicle-based fire extinguisher |
| 5,121,797 | Methods and apparatus for shutting in a burning oil well |
| 5,124,053 | Fire extinguishing methods and blends utilizing hydrofluorocarbons |
| 5,135,054 | Fire extinguishing agents for flooding applications |
| 5,146,996 | Apparatus and method for thrusting a cover over a target area |
| 5,152,345 | Fire extinguishing tool |
| 5,154,237 | Detonation suppression |
| 5,154,238 | Vehicular fire protection apparatus |
| 5,158,138 | Apparatus for shutting in a burning oil well |
| 5,163,517 | Fire extinguishing systems |
| 5,174,384 | Transport unit for fluid or solid materials or devices, and method |
| 5,183,117 | Fire extinguisher |
| 5,211,245 | Vehicle mounted aerial lift |
| 5,211,246 | Scouring method and system for suppressing fire in an enclosed area |
| 5,224,550 | Explosion suppression system |
| 5,232,053 | Explosion suppression system |
| 5,244,021 | Fuel transfer container |
| 5,249,631 | Water powered mobile robot |
| 5,275,243 | Dry powder and liquid method and apparatus for extinguishing fire |
| 5,275,244 | Apparatus and process for extinguishing fires with a noncombustible fluid in |
| | liquid and gaseous states |
| 5,276,433 | Methods and apparatus for temperature sensing |
| 5,277,256 | Firefighter's nozzle |
| 5,301,756 | Vehicle mounted aerial lift |
| 5,305,957 | Process and apparatus for the fine dispersion of liquids or powders in a gaseous |
| | medium |
| 5,340,490 | Azeotrope-like compositions of trifluoromethane and carbon dioxide or |
| | hexafluoroethane and carbon dioxide |
| 5,361,847 | Failsafe phial-type fire extinguishing system |
| 5,368,106 | Fire-fighting tool particularly for shipboard fires and the like |
| 5,370,189 | Fire extinguisher bottle with pick-up tube |
| 5,393,438 | Fire extinguishing composition and process |
| 5,402,967 | Apparatus for supplying water to aircraft cabin spray systems |
| 5,409,067 | Portable fire fighting tool |
| 5,423,384 | Apparatus for suppressing a fire |
| 5,423,385 | Fire extinguishing methods and systems |
| 5,425,426 | Fire extinguishing methods and systems |
| 5,425,886 | On demand, non-halon, fire extinguishing systems |
| 5,441,114 | Portable system for extinguishing a fire |
| 5,449,041 | Apparatus and method for suppressing a fire |
| 5,458,202 | Pressurized extinguishant release device with rolling diaphragm |
| 5,465,795 | Fire suppressing apparatus for generating steam from a water-ice mixture |
| 5,492,179 | System for extinguishing a fire in a volume for delivery from a distance |
| 5,492,180 | Painting wall surfaces with an ignitable solid-fuel composition which generates a |
| | fire-extinguishing particulate aerosol |
| 5,495,893 | Apparatus and method to control deflagration of gases |
| 5,501,284 | Inflatable bag fire extinguishing system |
| 5,505,383 | Fire protection nozzle |
| 5,511,621 | Local flooding fine water spray fire suppression system using recirculation |
| | principles |
| 5,518,075 | Fire extinguisher |
| 5,534,164 | Non-toxic, environmentally benign fire extinguishants |
| 5,573,067 | Apparatus for extinguishing an oil well fire |
| 5,575,341 | Mechanical foam fire fighting equipment and method |
| 5,588,493 | Fire extinguishing methods and systems |
| 5,588,987 | Discharge stream conditioner and method |
| 5,597,044 | Method for dispersing an atomized liquid stream |
| 5,609,210 | Apparatus and method for suppressing a fire |
| 5,609,787 | Method for extinguishing fire |
| 5,610,359 | Method of generating non-toxic smoke |
| 5,613,562 | Apparatus for suppressing a fire |
| 5,615,742 | Noncombustible hydrogen gas containing atmospheres and their production |
| 5,617,923 | Modular fire extinguishing apparatus for an enclosed environment |
| 5,626,786 | Labile bromine fire suppressants |
| 5,647,438 | Explosion suppressant dispersion nozzle |
| 5,651,417 | Base for a fire-fighting tool |
| 5,664,631 | Apparatus for impulse fire extinguishing |
| 5,678,638 | Spark and flame suppression system |
| 5,685,376 | System and method utilizing low-pressure nozzles for extinguishing fires |
| 5,718,293 | Fire extinguishing process and composition |
| 5,718,294 | Fire suppression or explosion protection system having a manual actuator for an |
| | electrically responsive initiator or gas-generating cartridge activator |
| 5,727,635 | Vehicular and marine fire suppression system |
| 5,759,430 | Clean, tropodegradable agents with low ozone depletion and global warming |
| | potentials to protect against fires and explosions |
| 5,775,434 | Fire fighting method and installation for extinguishing an elongated object |
| 5,785,126 | Method of extinguishing of fire in open or closed spaces and means for |
| | performing the method |
| 5,785,127 | User back-mounted fire suppressor |
| 5,808,541 | Hazard detection, warning, and response system |
| 5,826,664 | Active fire and explosion suppression system employing a recloseable valve |
| 5,833,874 | Fire extinguishing gels and methods of preparation and use thereof |
| 5,845,714 | Method and installation for fire extinguishing using a combination of liquid fog |
| | and a non-combustible gas |
| 5,845,716 | Method and apparatus for dispensing liquid with gas |
| 5,848,650 | Vehicular engine combustion suppression method |
| 5,848,652 | Engine fire extinguishment system |
| 5,850,876 | Apparatus and system for the storage and supply of liquid CO.sub.2 at low |
| | pressure for extinguishing of fires |
| 5,856,587 | Flame extinguishing compositions |
| 5,857,627 | Foam-forming nozzle |
| 5,862,867 | Gas-liquid mixture as well as unit and method for the use thereof |
| 5,881,817 | Cold compressed air foam fire control apparatus |
| 5,884,710 | Liquid pyrotechnic fire extinguishing composition producing a large amount of |
| | water vapor |
| 5,894,891 | Method and device for extinguishing fires |
| 5,909,776 | Fire extinguishers |
| 5,913,367 | Aircraft penetrator |
| 5,918,680 | Water spray cooling system for extinguishment and post fire suppression of |
| | compartment fires |
| 5,919,393 | Fire extinguishing process and composition |
| 5,921,322 | Device for regulating speed of deployment of sprinkler heads in preactive |
| | sprinkler systems |
| 5,934,379 | Method and apparatus for detection and prevention of fire hazard |
| 5,934,380 | Apparatus for preparing and disseminating novel fire extinguishing agents |
| 5,947,207 | Dual sprinkler system |
| 5,954,138 | Fire extinguisher valve and fire-extinguishing equipment |
| 5,971,080 | Quick response dry pipe sprinkler system |
| 5,975,213 | Fire suppression device |
| 5,984,016 | Fire extinguisher for closed spaces |
| 5,992,528 | Inflator based fire suppression system |
| 5,993,682 | Hydrobromocarbon blends to protect against fires and explosions |
| 6,003,608 | Fire suppression system for an enclosed space |
| 6,012,531 | Fire extinguishing bomb |
| 6,016,874 | Compact affordable inert gas fire extinguishing system |
| 6,019,177 | Methods for suppressing flame |
| 6,024,889 | Chemically active fire suppression composition |
| 6,029,751 | Automatic fire suppression apparatus and method |
| 6,032,745 | Valve for fire suppression device |
| 6,047,777 | Method and device for suppressing an explosion-like fire, in particular of |
| | hydrocarbons |
| 6,053,256 | Fire extinguishing system |
| 6,053,256 | Fire extinguishing system |
| 6,056,063 | Thermo-controlled, self-explosive fire extinguisher |
| 6,065,546 | Fire extinguishing and smoke eliminating apparatus and method using water mist |
| 6,065,547 | Apparatus and method for fire suppression |
| 6,068,058 | Apparatus and method for fire supression |
| 6,076,610 | Vehicular fire extinguishing device |
| 6,082,464 | Dual stage fire extinguisher |
| 6,089,324 | Cold compressed air foam fire control apparatus |
| 6,095,251 | Dual stage fire extinguisher |
| 6,104,301 | Hazard detection, warning, and response system |
| 6,112,822 | Method for delivering a fire suppression composition to a hazard |
| 6,131,667 | Manual and automatic fire extinguishing systems |
| 6,138,766 | Apparatus for preparing and disseminating novel fire extinguishing agents |
| 6,146,544 | Environmentally benign non-toxic fire flooding agents |
| 6,164,382 | Pyrotechnical device and process for extinguishing fires |
| 6,173,790 | Process and device for atomizing liquid extinguishing agents in stationary |
| | extinguishing installations |
| 6,182,768 | Gas-liquid mixture as well as fire-extinguishing unit and method for the use |
| | thereof |
| 6,189,625 | Liquid mist fire extinguisher |
| 6,202,755 | Fire extinguishing agent and method of preparation and use thereof |
| 6,216,963 | Device for regulating speed of deployment of sprinkler heads in preactive |
| | sprinkler systems |
| 6,241,164 | Effervescent liquid fine mist apparatus and method |
| 6,257,340 | Fire extinguishing system using shock tube |
| 6,267,788 | Gas-Liquid mixture as well as fire-extinguishing unit and method for the use |
| | thereof |
| 6,314,754 | Hypoxic fire prevention and fire suppression systems for computer rooms and |
| | other human occupied facilities |
| 6,317,053 | Switch cabinet with a fire extinguishing system |
| 6,318,473 | Expansive fire extinguishing system |
| 6,346,203 | Method for the suppression of fire |
| 6,352,648 | Environmentally benign non-toxic fire flooding agents |
| 6,367,560 | Wet sprinkler system for cold environments |
| 6,390,203 | Fire suppression apparatus and method |
| 6,394,188 | Vehicular fire extinguishing device |
| 6,401,487 | Hypoxic fire prevention and fire suppression systems with breathable fire |
| | extinguishing compositions for human occupied environments |
| 6,401,830 | Fire extinguishing agent and method |
| 6,402,975 | Environmentally benign non-toxic fire flooding agents |
| 6,418,752 | Hypoxic fire prevention and fire suppression systems and breathable fire |
| | extinguishing compositions for human occupied environments |
| 6,419,027 | Fluoroalkylphosphorus compounds as fire and explosion protection agents |
| 6,422,320 | Enhanced agent misting extinguisher design for fire fighting |
| 6,431,465 | On-off valve and apparatus for performing work |
| 6,478,979 | Use of fluorinated ketones in fire extinguishing compositions |
| 6,598,802 | Effervescent liquid fine mist apparatus and method |
| 6,601,653 | Method and system for extinguishing fire in an enclosed space |
| 6,637,518 | Fire extinguishing apparatus |
| 6,676,081 | System for extinguishing and suppressing fire in an enclosed space in an aircraft |
| 6,695,068 | Textile and cordage net fire extinguisher system |
| 6,702,033 | Hybrid fire extinguisher |
| 6,732,809 | Apparatus for distributing granular material |
| 6,739,400 | Process and installation for fighting a fire in an aircraft compartment and aircraft |
| | equipped with such an installation |
| 6,745,847 | Fire extinguishing spray nozzle |
| 6,763,894 | Clean agent fire suppression system and rapid atomizing nozzle in the same |
| 6,796,382 | Fire extinguishing ball |
| 6,810,964 | Pressurization system for fire extinguishers |
| 6,840,331 | Portable breathable fire extinguishing liquefied gas delivery system |
| 6,849,194 | Methods for preparing ethers, ether compositions, fluoroether fire extinguishing |
| | systems, mixtures and methods |
| 6,851,483 | Fire suppression system and solid propellant aerosol generator for use therein |
| 6,860,333 | Thermally activated fire suppression system |
| 6,868,915 | Method for suppressing developing explosions |
| 6,871,802 | Self-modulating inert gas fire suppression system |
| 6,889,775 | Retrofitted non-Halon fire suppression system and method of retrofitting existing |
| | Halon based systems |
| 6,899,184 | Fire suppression system and method for an interior area of an aircraft lavatory |
| | waste container fire protection |
| 6,902,009 | Fire extinguisher with means for preventing freezing at outlet |
| 6,907,940 | Fast response fluid flow control valve/nozzle |
| 6,935,433 | Helium gas total flood fire suppression system |
| 6,981,659 | Liquid mist fire extinguisher |
| 6,983,805 | Fire blanket |
| 6,988,558 | Fire extinguishing method by gas and extinguishing device |
| 7,004,261 | Microemulsion mists as fire suppression agents |
| 7,011,164 | Engine disabler spray system |
| 7,028,782 | System and method for suppressing fires |
| 7,048,068 | Fire extinguishing system for large structures |
| 7,066,274 | Fire-suppression system for an aircraft |
| 7,082,999 | Pressurization system for fire extinguishers |
| 7,083,742 | Fluoroiodocarbon blends as CFC and halon replacements |
| 7,089,862 | Water pod |
| 7,090,028 | Fire suppression using water mist with ultrafine size droplets |
| 7,121,353 | Airborne vehicle for firefighting |
| 7,121,354 | Fire extinguishing device and method |
| 7,128,163 | Self servicing fire extinguisher with external operated internal mixing with wide |
| | mouth and external CO.sub.2 chamber |
| H141 | Fast dispensing fire extinguisher |
| RE29,614 | Rupturing head for fire extinguishers |

What is claimed is:

1. An inflator employing a propellant produced from a BTATz material, comprising in combination:
a gas cartridge having an outlet for fluid connection to an inflatable article;
the gas cartridge including a reaction chamber that contains the BTATz material and controls the gas evolution rate as the BTATz material is ignited;
a cover fitted to the reaction chamber; and
a housing in which the reaction chamber is positioned including a dome providing a headspace volume for the nitrogen gas produced upon ignition of the BTATz material.

2. A BTATz air bag inflation device comprising in combination:
a vented housing in which is positioned an internal cavity filled with BTATz; and
an igniter positioned within the bottom of the cavity with its firing leads extending through the housing for connection to a firing mechanism.

3. A BTATz fire suppressant, comprising a container filled with BTATz that, upon ignition, produces fire-suppressing nitrogen gas.

4. A BTATz fire extinguisher, comprising in combination:
a gas cylinder containing BTATz and a pressurized gas; and
a hand-operated dispensing valve/nozzle that release the pressurize gas to dispense the BTATz.

5. A BTATz fire extinguisher, comprising in combination:
a container including a supply of BTATz; and
a valve including an igniter to ignite the BTATz whereupon expanding nitrogen gas produced from the burning BTATz pressurizes the container which is then used to suppress a fire.

6. A BTATz inflator, comprising in combination:
a housing;
a BTATz charge container including an amount of BTATz and a primer charge, the charge container being positioned within the housing;
an igniter extending into the primer charge to ignite the primer charge which in turn ignites the BTATz;
the housing including an exhaust port such that upon ignition of the BTATz a supply of nitrogen gas is produced that is exhausted from the housing into an article to be inflated.

7. A BTATz tire inflator, comprising in combination:
a housing;
a charge container containing BTATz, the container including a spark gap for creating a spark when voltage is applied to its leads, the charge container being positioned within the housing;
a piezoelectric mechanism including a push-button that when pressed, creates a spark of voltage by the piezoelectric that is supplied to the leads of the spark gap to ignite the BTATz whereupon the nitrogen gas produced therein is vented into housing; and
a valve positioned within the housing designed to open a conventional inflation valve of a standard automotive tire, whereupon the nitrogen gas in the housing is used to inflate the tire.

8. A BTATz inflator, comprising in combination:
a housing;
a charge container containing BTATz positioned within the housing, the charge container including a percussion cap to ignite the BTATz upon being stuck; and
a firing mechanism for striking the percussion cap upon the jerking of a lanyarded pull handle.

9. A BTATz alternative fuel engine, comprising a combustion chamber including an igniter to fire a charge of BTATz therein and produce pressurized nitrogen gas to drive an engine.
